(19) United States
(12) Patent Application Publication
(10) Pub. No.: US 2013/0110839 A1
(43) Pub. Date: May 2, 2013

(54) CONSTRUCTING AN ANALYSIS OF A DOCUMENT

(71) Applicant: Evan R. Kirshenbaum, Mountain View, CA (US)

(72) Inventor: Evan R. Kirshenbaum, Mountain View, CA (US)

(21) Appl. No.: 13/286,024

(22) Filed: Oct. 31, 2011

(51) Int. Cl. G06F 17/30

(52) U.S. Cl. 707/740; 707/737; 707/748; 707/E17.014; 707/E17.089

(57) ABSTRACT

Systems, methods, and computer-readable and executable instructions are provided for constructing an analysis of a document. Constructing an analysis of a document can include determining a plurality of features based on the document, wherein each of the plurality of features is associated with a subset of a set of concepts. Constructing an analysis of a document can also include constructing a set of concept candidates based on the plurality of features, wherein each concept candidate is associated with at least one concept in the set of concepts. Furthermore, constructing an analysis of a document can include choosing a subset of the set of concept candidates as winning concept candidates and constructing an analysis that includes at least one concept in the set of concepts associated with at least one of the winning concept candidates.

### BACKGROUND

Determining a user's interest can include the observation and tracking of tags, or non-hierarchical keywords or terms assigned to a piece of information. A tag can describe an item and allow it to be found again by browsing or searching. In a typical tagging system, manual tagging is relied on either by an author of the document or by viewers of the document (e.g., “Web 2.0”). Tagging is infrequently done, so many documents do not have tags, and those documents that are tagged can include inconsistent tagging. Different taggers may have different sets of tags that they apply, and these differences can be difficult to map. Tagging may not allow for sufficient interest-tracking. Tagging can also include training text classifiers to run on a document and take concepts whose classifiers produce a threshold score. However, this technique can require a large time commitment and large budget.

### BRIEF DESCRIPTION OF THE DRAWINGS

FIG. 1 is a flow chart illustrating an example method for constructing an analysis of a document according to the present disclosure.

FIG. 2A is a block diagram of an example of a concept extractor used in constructing an analysis of a document according to the present disclosure.

FIG. 2B is a block diagram illustrating a processing system configured to generate an analysis from a document using a concept extractor.

FIGS. 3A and 3B are flow charts illustrating example methods for constructing an analysis of a document according to the present disclosure.

FIG. 4 is a block diagram of an example of a number of categories and their hierarchies used in constructing an analysis of a document according to the present disclosure.

FIG. 5 is a block diagram of example arrays for use in constructing an analysis of a document according to the present disclosure.

FIG. 6 is a block diagram of an example offline string table used in constructing an analysis of a document according to the present disclosure.

FIG. 7 is a block diagram of an example of a parsed text object used in constructing an analysis of a document according to the present disclosure.

FIG. 8A is a block diagram of an example n-grammer used in constructing an analysis of a document according to the present disclosure.

FIG. 8B is a block diagram of an example n-gram used in constructing an analysis of a document according to the present disclosure.

FIG. 9 is a block diagram of an example uniform map set used in constructing an analysis of a document according to the present disclosure.

FIG. 10 is a block diagram of an example of feature records used in constructing an analysis according to the present disclosure.

FIG. 11 is an example of a feature set and a feature count map used in constructing an analysis of a document according to the present disclosure.

FIG. 12 is a block diagram of an example constructed analysis object according to the present disclosure.

FIG. 13 is a block diagram of an example of an implementation of a categorizer used in constructing an analysis of a document according to the present disclosure.

FIG. 14A is a block diagram of an example feature priority object used in constructing an analysis according to the present disclosure.

FIG. 14B is a flow chart of an example method for removing overlapping features from a feature set, as used in constructing an analysis of a document according to the present disclosure.

FIG. 15 is a flow chart of an example method for filtering and merging features according to the present disclosure.

FIG. 16 is a block diagram of a neighborhood object and data structures used to construct the neighborhood object according to the present disclosure.

FIG. 17 is a block diagram of an example decode table used in constructing an analysis of a document according to the present disclosure.

FIG. 18 is a block diagram of an example concept candidate according to the present disclosure.

FIG. 19 is block diagram of an example imputation used in selecting a set of winning concept candidates according to the present disclosure.

FIG. 20 is a flow chart of an example method for setting up an election based on a feature count map according to the present disclosure.

FIG. 21 is a flow chart of an example election method used in choosing winning concept candidates from a set of candidates in an election according to the present disclosure.

FIG. 22 is a block diagram of an example category candidate according to the present disclosure.

FIG. 23 is a flow diagram of an example method for constructing a map from concepts to sets of category paths given a set of winning concept categories and a categorization according to the present disclosure

FIG. 24 is a block diagram of an example evidence object according to the present disclosure.

FIG. 25 is a flow chart of an example method for associating evidence objects with category paths according to the present disclosure

FIG. 26 is a diagram of an example comparison of a raw score and a scaled score according to the present disclosure.

FIG. 27 is a flow chart of an example method for filtering category paths according to the present disclosure.

### DETAILED DESCRIPTION

Examples of the present disclosure may include methods, systems, and computer-readable and executable instructions and/or logic. An example method for constructing an analysis of a document may include determining a plurality of features based on the document, wherein each of the plurality of features is associated with a subset of a set of concepts. The example method may also include constructing a set of concept candidates based on the plurality of features, wherein each concept candidate is associated with at least one concept in the set of concepts. Furthermore, the example method may include choosing a subset of the set of concept candidates as winning concept candidates and constructing an analysis that includes at least one concept in the set of concepts associated with at least one of the winning concept candidates.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. References to logical entities in the figures or specification can include embodiments and/or examples in which such entities are not identifiable as single entities as implemented, including examples in which the functions performed by the logical entities are implemented by other components or by the system as a whole.

In this description, the phrase “document” can include any tangible or on-line object with which features may be associated. Methods can include the use of textual documents, that is, documents that consist at least in part of sequences of words in a natural human language, optionally organized into structures such as sentences, paragraphs, sections, chapters, titles, and/or keywords, where features may include words, phrases, word sequences, characters, character sequences, and/or statistics computed based on such features. Features may also include information relating to the relationship of documents to one another, such as hypertext “links” specified by uniform resource locators (URLs). Textual documents can include, without limitation, web pages, newspaper and magazine articles, books, scripts, poems, scholarly papers, catalog descriptions, program guide descriptions, electronic mail (e-mail) messages, blog postings, comments on web pages, status updates and/or comments on social media sites such as Facebook®, Twitter® messages, short message service (SMS) messages, instant messaging (IM) messages, advertisements, computer program source code, computer program documentation, help files, other textual computer files, textual data in computer databases, audio transcripts, and/or depositions.

Documents may also be parts of other documents or collections of documents, where such a collection may be implied by various means such as a document and documents it refers to (e.g., a Twitter message and any web pages referred to by URLs in the Twitter message), documents that are declared or inferred to be related to one another (e.g., multiple web pages that are parts of an overarching article), or documents a user interacts with in a given session of activity. In addition, a document may be a non-textual object that has text associated with it. Examples of such non-textual objects include, without limitation, motion pictures and television shows, with associated scripts, advertising materials, audio transcripts, subtitles, reviews, program guide listings, and/or descriptive web pages on web sites such as Wikipedia and/or the Internet Movie Database (IMDb); songs, with associated lyrics and/or descriptive web pages; computer programs and/or mobile phone apps, with associated product descriptions, reviews, documentation, and/or help files; people, with associated biographies and/or descriptive web pages; and goods and services available for purchase, with associated product descriptions and/or reviews. In some examples, documents may include objects that do not have associated text but from which features may be extracted that can be associated with concepts as required and described below.

From such a document and based at least in part on features associated with it, an analysis of the document can be constructed, where the analysis is an object containing a set of concepts implied as being relevant to the document. Each concept in the analysis can be drawn from a certain (e.g., preferably large) ontology or concept base containing a set of concepts that may be relevant to different documents. In an example, the concept base is considered to be isomorphic to a subset of the set of articles in Wikipedia, with each concept identified with a Wikipedia article. Alternative examples may employ other ontologies, such as the Library of Congress, Dewey Decimal, or Readers' Guide to Periodical Literature classifications, or may employ ontologies created for the purpose of constructing such analyses. In some embodiments, the analysis may also contain a set of categories, which may be hierarchical and which can represent broad topic areas implied as being relevant to the document. In some of these examples, some or all of the concepts may be associated with one or more categories, and these pairings can be referred to as “category paths”.

In some examples, concepts, category paths, and/or categories may be associated with a numeric score or other indication of the degree that the particular concept, category path, or category is considered to describe the document, ranging from an indication that the concept, category path, or category is merely mentioned in the document to an indication that that the document as saliently “about” the concept, category path, or category.

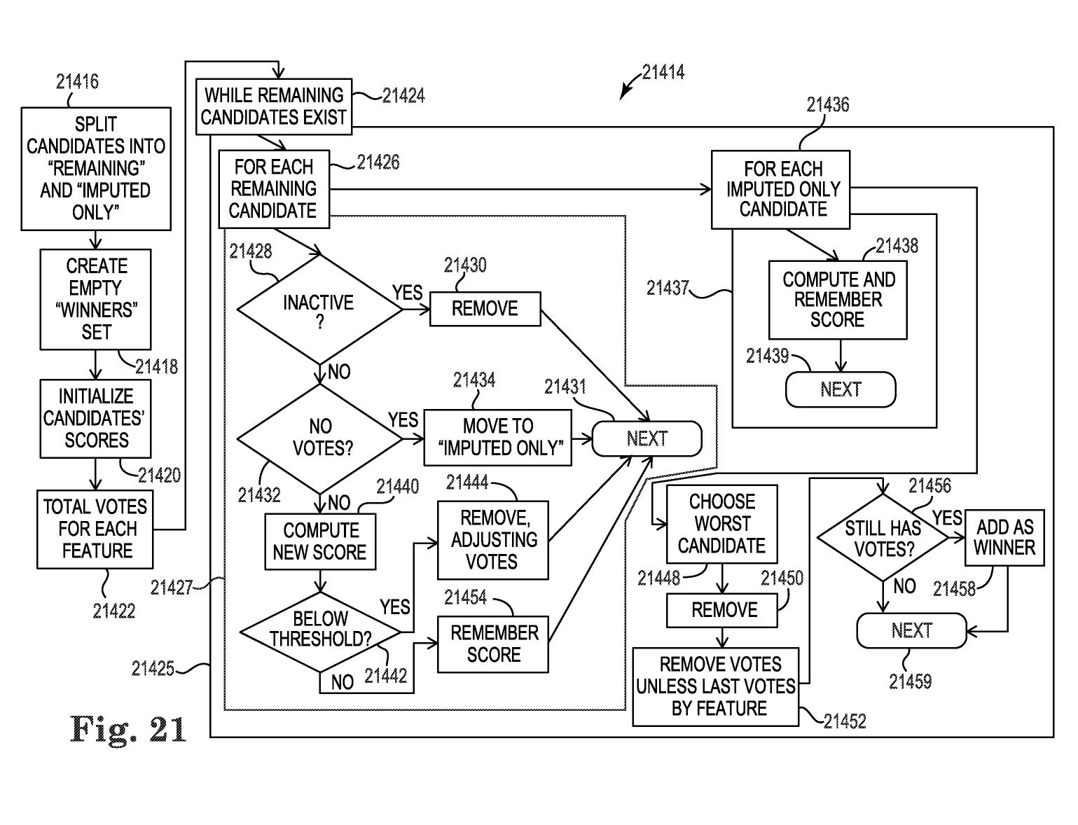

Features, including, without limitation, words and phrases, which do not only give evidence by their presence that a concept or category is descriptive of a document but are themselves taken to refer (possibly ambiguously and/or possibly not in all cases) to concepts or categories may be considered to be “potential concept indicators”, and the process of determining concepts or categories descriptive of a document may involve determining which, if any, concepts and categories are referred to by observed potential concept indicator features. This process of determining a referent for a feature may involve a process (such as method 21414 described below with respect to FIG. 21) in which the process of determining a set of concepts involves features becoming associated with a single concept or category as their most likely referent.

The constructed analysis may be used to facilitate many tasks related to the document. For example, it may be used to identify the document as relevant to a user's search, and/or it may be used to determine a placement of the document in an abstract storage hierarchy or on a physical storage device. It may also be used to determine a management policy to apply to the document, and it may be used to identify a user to route the document to (as, for example, by e-mail) or a user to whose attention the document's existence should be brought. The constructed analysis may also be used to identify the document as potentially interesting to a particular user so that the document may be recommended to the user. Such recommendation may take the form of selecting the document (or information related to it) for inclusion in a catalog, magazine, web page, e-mail message, or list. It may be used in the construction and modification of a profile associated with a user who interacts with the document. In such an example, the analysis, optionally along with an indication from the user of a degree to which the user found the document interesting or not, may be used to construct a profile that indicates a degree of belief that the user finds and will find interesting documents associated with certain concepts, category paths, and categories. Such a profile may be used to select other documents as interesting to the user based on the analyses constructed for the other documents.

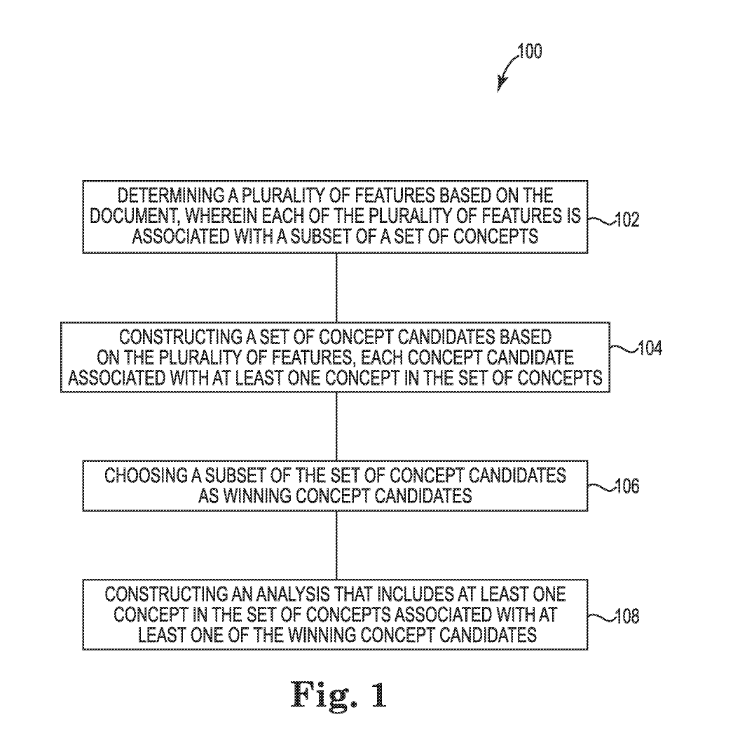

FIG. 1 is a flow chart illustrating an example method 100 for constructing an analysis of a document according to the present disclosure. At 102, a plurality of features based on the document are determined, and each of the plurality of features is associated with a subset of a set of concepts. Information about the number of times each of these features occurs and the locations within the structure of the document in which these occurrences are found may be stored in a data structure called a “feature count map”. At 104, a set of concept candidates is constructed based on the plurality of features, wherein each concept candidate is associated with at least one concept in the set of concepts. A concept candidate is or is associated with a concept that is to be considered for inclusion in the analysis to be constructed by method 100. At 104, the set of concept candidates can include concept candidates associated with concepts associated with features in the plurality of features.

A subset of the set of concept candidates is chosen as winning concept candidates at 106, and at 108, an analysis that includes at least one concept in the set of concepts associated with at least one of the winning concept candidates is constructed. At least a portion of the concepts associated with the winning concept candidates can be included in an analysis that is constructed at 108. The concepts included in the analysis may also include concepts not associated with concept candidates in the set constructed at 104.

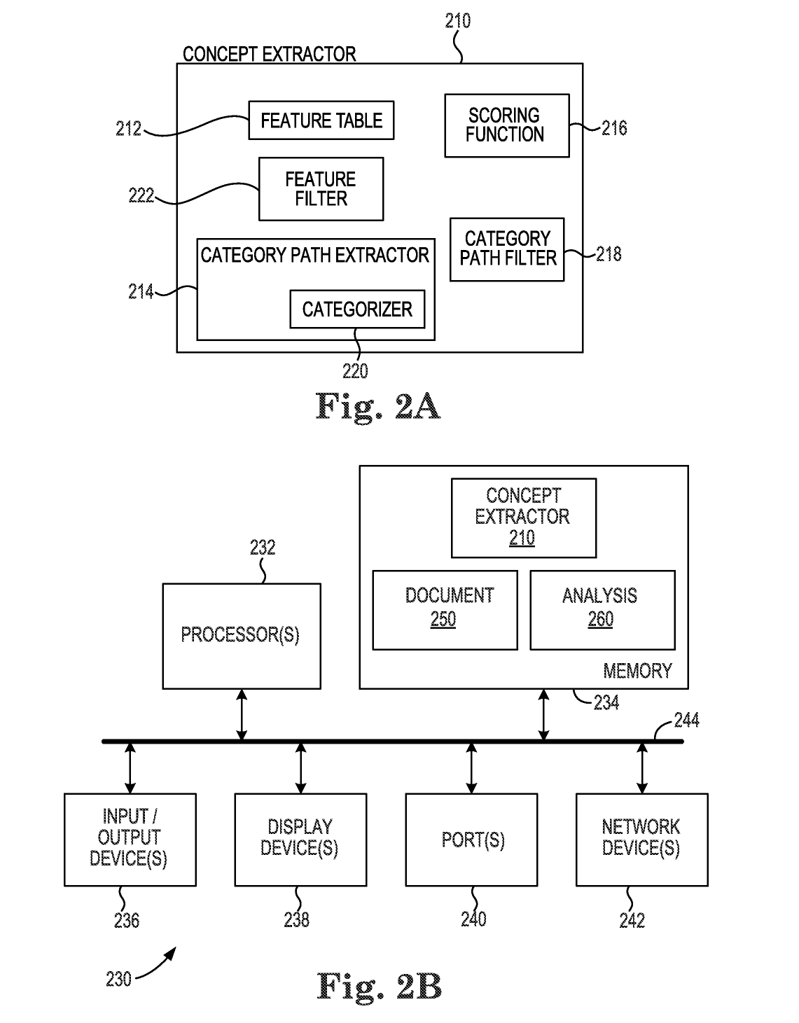

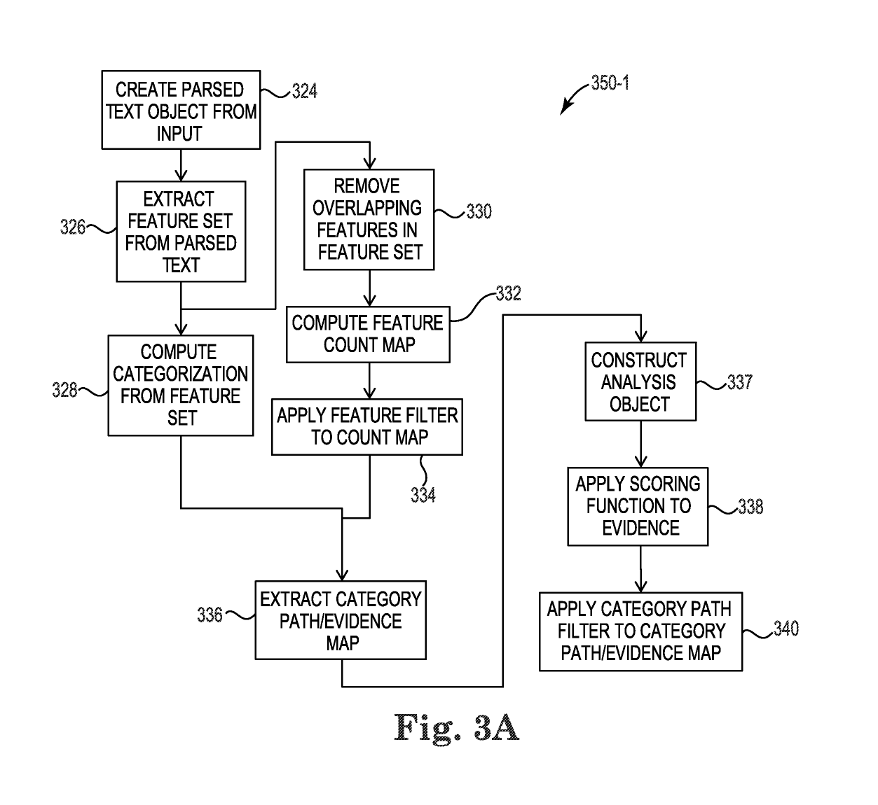

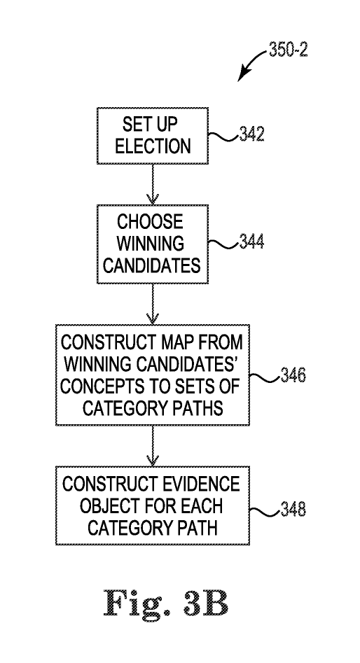

FIG. 2A is a block diagram of an example of a concept extractor 210 used in constructing an analysis of a document according to the present disclosure. Concept extractor 210 can extract concepts from the document, and it can include a number of components. The components can be replaceable. A feature table 212 can indicate which features in the document can be used in an analysis. Feature table 212 can also indicate which concepts each feature implies, and with what probability. This will be discussed further in relation to FIG. 3A.

Concept extractor 210 can also include a feature filter 222. Feature filter 222 can remove particular features from the plurality of features or cause multiple features in the plurality of features to be treated as a single feature. Scoring function 216 can also be included in concept extractor 210 and can assign scores to category paths based on associated evidence. These scores can indicate a degree to which a concept was believed to have been mentioned in passing in the document and/or a degree to which the document was believed to have saliently been about the concept or the concept was believed to have been a major topic of discussion in the document.

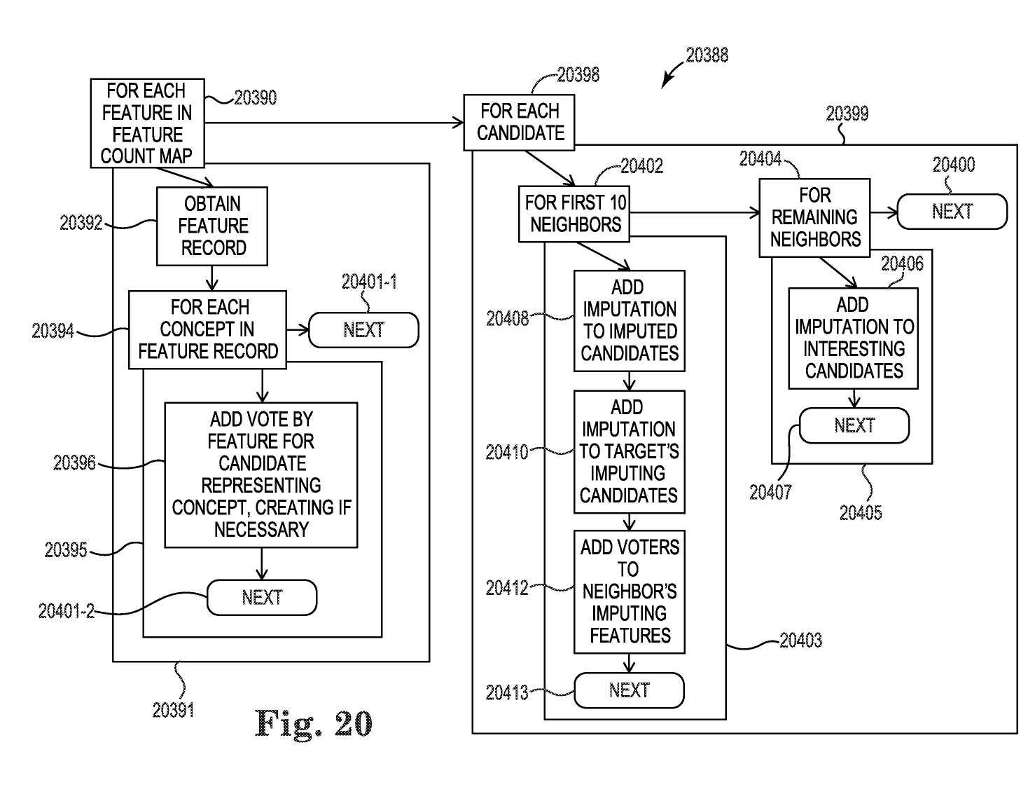

Concept extractor 210 can further include category path extractor 214 and categorizer 220. Category path extractor 214 determines a set of category paths (and the concepts included in the category paths) that apply to the document using the information about the plurality of features determined at 102 of method 100 and the associated count map, as well as a categorization determined by categorizer 220 based on the features and the count map. Category path extractor 214 also determines evidence associated with each category path. Category path extractor 214 can also model the choice of concepts as an election, in which the features are considered to be voters, and choose a set that matches evidence across the features seen as described below with reference to FIGS. 20 and 21. When running the election, category path extractor 214 can force each feature to eventually choose to support (and become evidence for) at most a single concept. Category path filter 218, which can also be included in concept extractor 210, can identify category paths in the set constructed by category path extractor 214 that are to be excluded from an analysis based on support in the document for particular categories, category paths, and/or concepts.

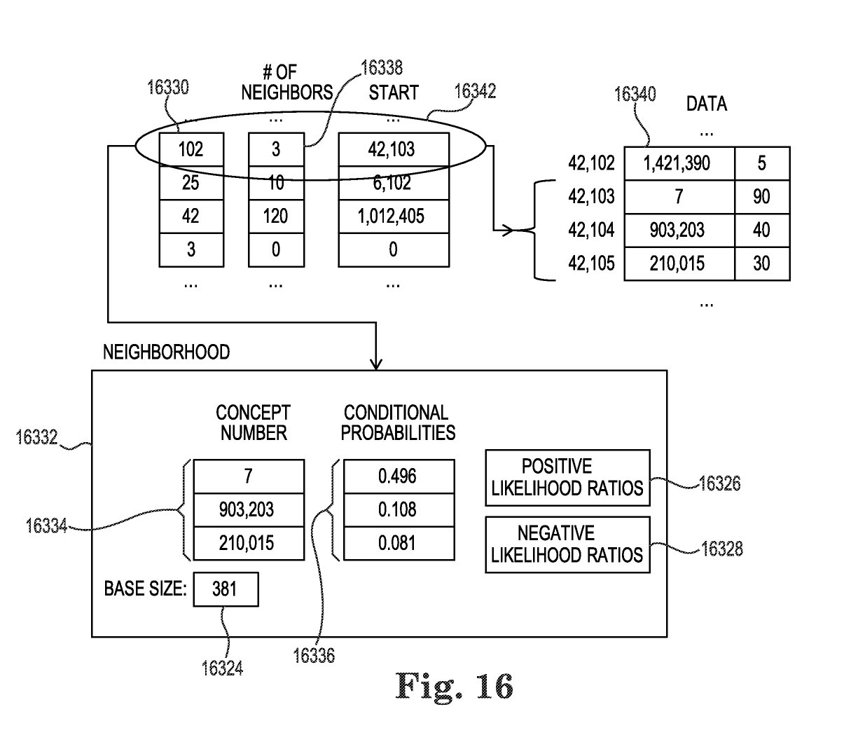

Category path extractor 214 can include categorizer 220 that can use merged and deleted features to determine a categorization of the document which contains a degree to with the document reflects each of various categories. In addition, global tables containing information for categories, concepts, and neighborhoods can be used in the construction of an analysis. A neighborhood can model the likelihood that one concept is mentioned in a document given that other concepts are mentioned, and will be further discussed with respect to FIG. 16.

FIG. 2B is a block diagram illustrating processing system 230 configured to generate an analysis 260 from a document 250 using concept extractor 210.

Processing system 230 includes at least one processor 232 configured to execute machine readable instructions stored in a memory system 234. Processing system 230 may also include any suitable number of input/output devices 236, display devices 238, ports 240, and/or network devices 242. Processors 232, memory system 234, input/output devices 236, display devices 238, ports 240, and network devices 242 communicate using a set of interconnections 244 that includes any suitable type, number, and/or configuration of controllers, buses, interfaces, and/or other wired or wireless connections. Components of processing system 230 (for example, processors 232, memory system 234, input/output devices 236, display devices 238, ports 240, network devices 242, and interconnections 244) may be contained in a common housing (not shown) or in any suitable number of separate housings (not shown).

Processing system 230 may execute a basic input/output system (BIOS), firmware, an operating system, a runtime execution environment, and/or other services and/or applications stored in memory 234 (not shown) that includes machine readable instructions that are executable by processors 232 to manage the components of processing system 230 and provide a set of functions that allow other programs (e.g., concept extractor 210) to access and use the components.

Processing system 230 represents any suitable processing device, or portion of a processing device, configured to implement the functions of concept extractor 210 as described herein. A processing device may be a laptop computer, a tablet computer, a desktop computer, a server, or another suitable type of computer system. A processing device may also be a mobile telephone with processing capabilities (i.e., a smart phone), a digital still and/or video camera, a personal digital assistant (PDA), an audio/video device, or another suitable type of electronic device with processing capabilities. Processing capabilities refer to the ability of a device to execute instructions stored in a memory 234 with at least one processor 232.

Each processor 232 is configured to access and execute instructions stored in memory system 234. Each processor 232 may execute the instructions in conjunction with or in response to information received from input/output devices 236, display devices 238, ports 240, and/or network devices 242. Each processor 232 is also configured to access and store data in memory system 234.

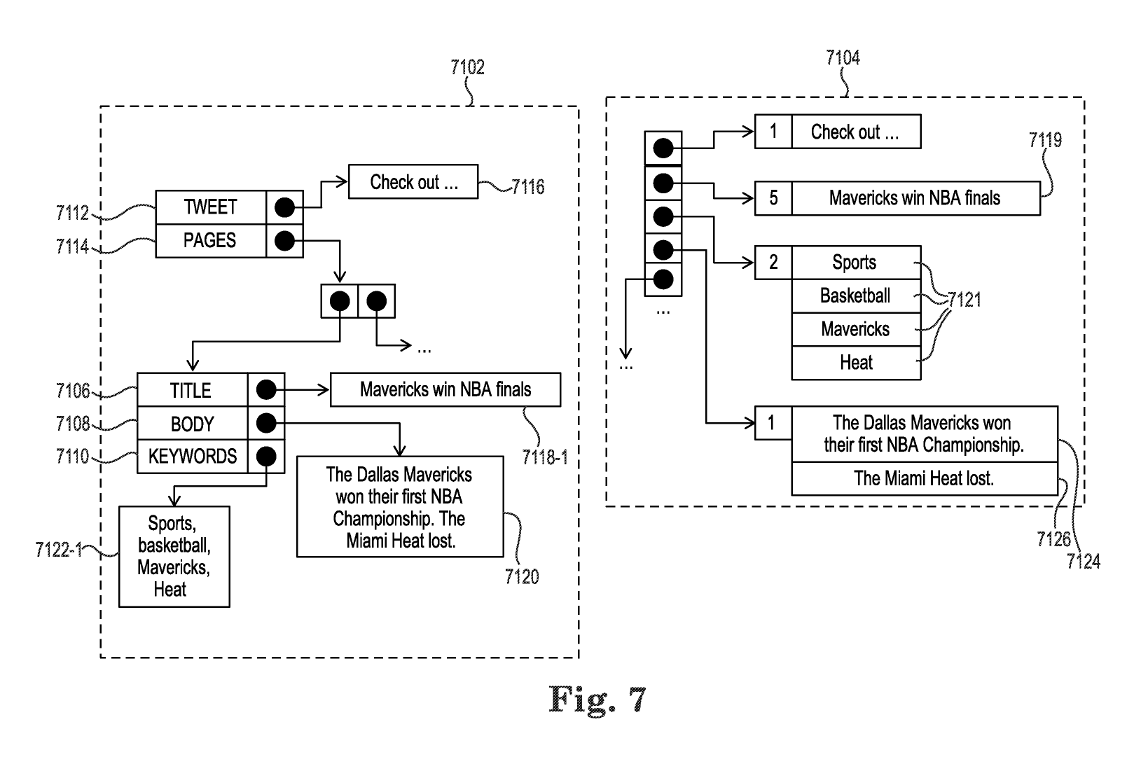

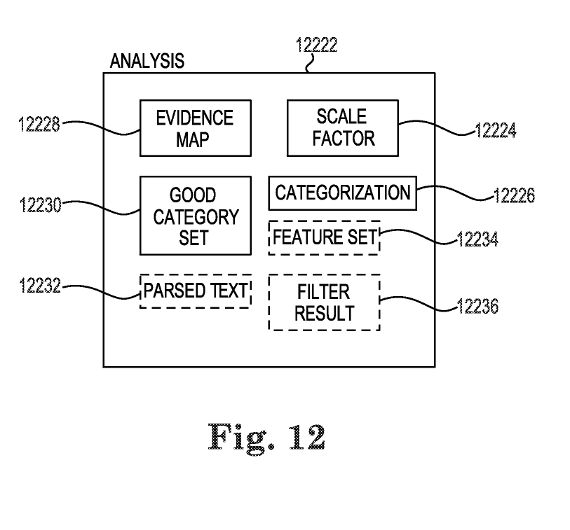

Memory system 234 includes any suitable type, number, and configuration of volatile or non-volatile storage devices configured to store instructions (e.g., concept extractor 210) and data (e.g., document 250 and analysis 260). An example of a document 250 includes input object 7102, as will be discussed further herein with respect to FIG. 7. Analysis 12222, as will be discussed further herein with respect to FIG. 12, represents an example of an analysis 260.

The storage devices of memory system 234 represent computer readable storage media that store computer-readable and computer-executable instructions including concept extractor 210. Memory system 234 stores instructions and data received from processors 232, input/output devices 236, display devices 238, ports 240, and network devices 242. Memory system 234 provides stored instructions and data to processors 232, input/output devices 236, display devices 238, ports 240, and network devices 242. The instructions are executable by processing system 230 to perform the functions and methods of concept extractor 210 described herein. Examples of storage devices in memory system 234 include hard disk drives, random access memory (RAM), read only memory (ROM), flash memory drives and cards, and other suitable types of magnetic and/or optical disks.

Input/output devices 236 include any suitable type, number, and configuration of input/output devices configured to input instructions and/or data from a user to processing system 230 and output instructions and/or data from processing system 230 to the user. Examples of input/output devices 236 include a touchscreen, buttons, dials, knobs, switches, a keyboard, a mouse, and a touchpad.

Display devices 238 include any suitable type, number, and configuration of display devices configured to output image, textual, and/or graphical information to a user of processing system 230. Examples of display devices 238 include a display screen, a monitor, and a projector.

Ports 240 include suitable type, number, and configuration of ports configured to input instructions and/or data from another device (not shown) to processing system 230 and output instructions and/or data from processing system 230 to another device.

Network devices 242 include any suitable type, number, and/or configuration of network devices configured to allow processing system 230 to communicate across one or more wired or wireless networks (not shown). Network devices 242 may operate according to any suitable networking protocol and/or configuration to allow information to be transmitted by processing system 230 to a network or received by processing system 242 from a network.

In constructing an analysis of a document, concepts and categories are extracted from the document. FIGS. 3A and 3B are flow charts illustrating example methods 350-1 and 350-2 for constructing an analysis of a document according to the present disclosure.

Example method 350-1, as illustrated in FIG. 3A, includes creating a parsed text object from input at 324. Document information to be analyzed can be collected, or it may already be available to analyze. An unordered collection of name/value pairs, or an “object” (e.g., a Java Script Object Notation (JSON) object) can characterize documents and document information (e.g., Twitter messages, or “tweets,” and web pages). Parsing this object can result in a parsed text object, as further discussed herein, with respect to FIG. 7.

At 326, a feature set is extracted from the parsed text. A feature table (e.g., table 212), which can associate with a feature an object that maps between concepts and probabilities, can be utilized to extract the feature set from the parsed text object. The feature table (e.g., table 212) can indicate which words and phrases may be of interest to a user, and which concepts they imply with what probability. The mapping object can encode a probability that an instance of the feature implies the presence of a concept. For example, a mapping object associated with a feature can include the probability that an instance of the word or phrase within some corpus (for example, Wikipedia) a document is text associated with a hyperlink to an article identified with a particular concept. In some cases a given feature may be associated, with different probability, to more than one concept. For example, “President Bush” may refer to the concept, “George W. Bush” and also to the “George H. W. Bush.” Features can also represent words and phrases that are not associated with links to other web pages or documents. Each of the number of features is characterized based on a content of the text and a location (or locations) of each of the number of features within the parsed text.

At 328, a categorization is computed for the features in the feature set. A feature set and/or document can be categorized based on the characterization of each of the number of features. For example, a web page may be determined about “sports” or, more specifically, “basketball.” The document may be associated with multiple categories and each such association may have a numerical strength determined. As will be further discussed herein, the document can be analyzed based on the categorization of the document, and an action can be performed based on the document analysis. In some examples, categories are not used and computing a categorization from a feature set at 328 may be omitted.

As previously noted, concepts represents topics that a document (e.g., a web page) can be “about” or that are mentioned in a document. For example, a concept can be identified with a particular Wikipedia® article. A concept can also include, but is not limited to, items in product catalogs, people in directories, web sites, books, and/or tags, among others. Each concept can have a number, and the numbers can be serially assigned. A concept can also have a name and a set of associated categories.

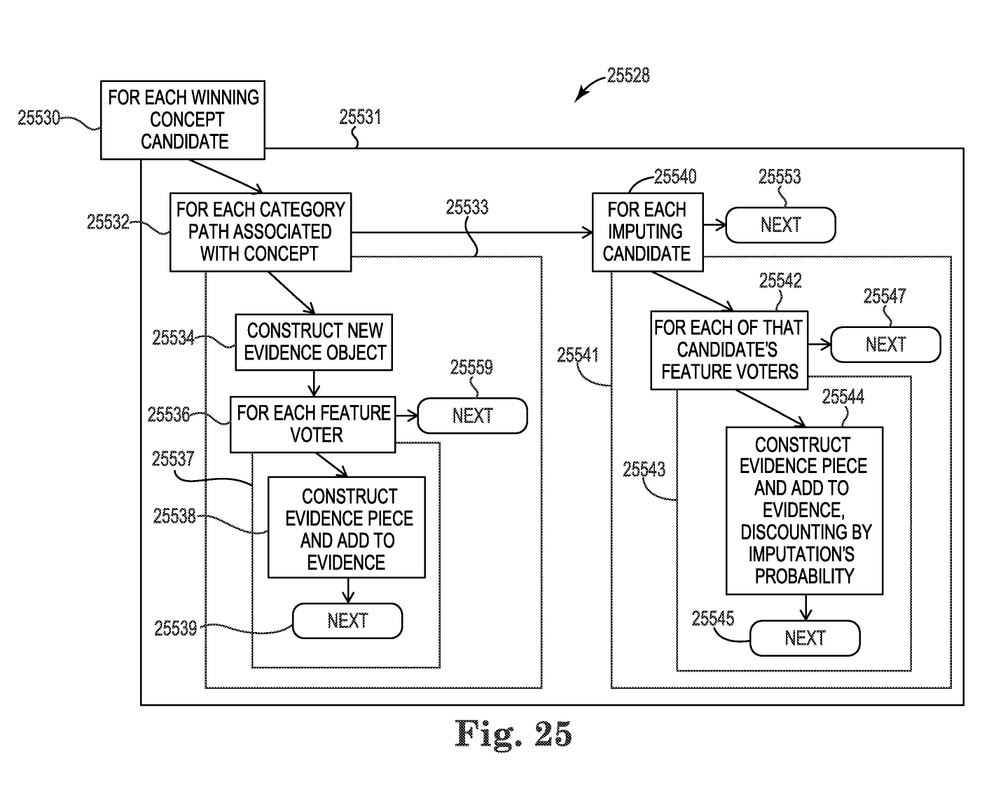

As will be discussed further herein, at 330, overlapping features in a feature set are removed, and a feature count map is computed at 332. Overlapping text can be removed so that each word in the text of the document is part of at most one feature. A count object can be an object that contains a count of the number of times a given feature appears and a weight based on the locations within the parsed text that the feature appears. A feature filter is applied to the feature count map at 334, and an evidence map which will be discussed further herein with respect to FIG. 25, is extracted at 336. The feature filter can remove features from the feature count (e.g., when it determines that evidence seen for the feature does not support a belief that the feature is present) or merge evidence from one feature into that associated with another (e.g., when it determines that there is sufficient evidence to believe that the first feature may more profitably be considered to be the second). In some examples, either or both of removing overlapping features in the feature set 330 and applying a feature filter to a count map 334 are performed prior to computing a categorization from a feature set 328 and the categorization is computed based on the resulting reduced feature set.

An analysis object is constructed at 337, and the analysis object can include a map from category paths to evidence (e.g., an evidence map), a set of categories that pass a filter, a categorization, a feature set, input sentences, a filter result describing how the feature set was filtered, and a “scale factor” representing a score (e.g., a maximum score) for a category path, as discussed further herein.

A scoring function is applied to each piece of evidence at 338. The evidence can be scored, and this can be done after the category paths have been determined and evidence for them set. The scoring function can include a category component and a concept component. A category path filter can be applied to the category path/evidence map at 340 to determine that some extracted category paths should be excluded from the analysis. Such a determination may be based on the category paths having less than a threshold level of support or less than a threshold amount in common with other category paths in the analysis.

FIG. 3B is a block diagram of an example method 350-2 for extracting a category path/evidence map (e.g., as illustrated at 336 of FIG. 3A) used in the constructing of an analysis of a document according to the present disclosure. At 342, an election is set up, and an election object is constructed with features identifying and voting for concept candidates. In some examples, no election object is constructed, but the items that may and/or would be associated with it are available to the method via other means (e.g., by being stored in predetermined locations). At 344, a “winning” set of concept candidates is chosen. At 346, the concepts associated with winning candidates are associated with categories, forming category paths, and a map is constructed from the winning candidates' concepts to sets of category paths. An evidence object is constructed for each category path at 348, as will be discussed further herein.

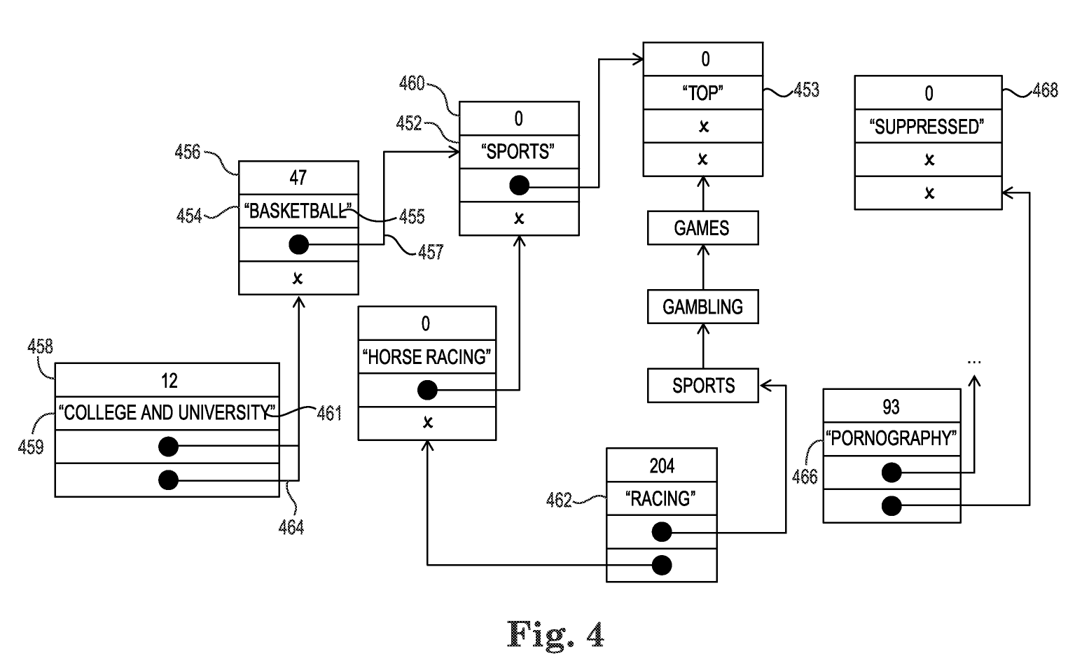

A categorization (e.g. a categorization computed at 328 of FIG. 3A) can be obtained based on the feature set. FIG. 4 is a block diagram of an example of a number of categories (e.g., categories 459, 454, 452, 453, 462, and 466) and their hierarchies used in constructing an analysis of a document according to the present disclosure. Categories represent a high-level way of describing the subject matter or topics of a document and can further be used as a way of organizing concepts. For example, features can be extracted from a document, categories can be determined based on those extracted features, and concepts can be associated with those categories. The set of categories can include, for example, “/Sports,” “/Sports/Baseball,” “/Society,” and “/Society/Issues/Poverty,” among others, where the slashes separate different levels of the category hierarchy. Categories can also be used to describe the notion that the document is relevant to a particular geographic region or demographic entity. An example of such a regional category might be “/Regional/North America/United States,” which represents the notion that the document has to do with the United States and is a subcategory of “/Regional North America”, which represents the notion that the document has to do with North America. A category can contain certain elements including its name 455 relative to its parent category (e.g., “Basketball” for category “/Sports/Basketball” 456). In some examples, a category may also contain or be associated with an encoded name (e.g., “United+States” for “United States”) representing a transformation of its name to facilitate manipulation, for example to allow a distinction between slashes within a category's name and slashes used to separate levels of the category hierarchy.

A category can also be given a unique category number 456. For example, category “/Sports/Basketball” 456 may be given a category number of 47, while category “/Sports/Basketball/College and University” 459 may have a different category number 458 (e.g., category number 12). Categories can be numbered sequentially with no number gaps, and categories can be located using their unique number.

A category can also have a parent category. For example, the category “/Sports/Basketball” 454 can have a parent category of “/Sports” 452, the association represented by link 457. Parent category 452 may or may not have a category number, or it may have a category number of zero, as shown at 460, which can indicate that the parent category is not a category that a categorizer can identify or recognize. For example, in FIG. 4, the categorizer (e.g., categorizer 220 as shown in FIG. 2) knows about “/Sports/Basketball” 454, but not “/Sports” 452, so “/Sports” 452 has a category number 460 of zero. In the example block diagram of FIG. 4, the category “Top” 453, which in some examples is written as “/”, the root category can be a parent category to Sports category 452. Root category 453 has no parent category, shown in FIG. 4 by an “x” in the parent category slot. Finally, a category can have an optional forwarding category, which can be the result of an external decision that a first category should be reported as a second category. For example, the category “/Sports/Basketball/College and University” 459 may be set to report as “/Sports/Basketball,” as is indicated by arrow 464, while category “/Sports/Basketball” 454 has no forwarding category (shown by an “x” in that field) and will be reported as “/Sports/Basketball”. The presence of forwarding categories may require that when the analysis is built the presence of several categories within the categorization that forward to the same category must be allowed for.

An optional forwarding category can be implemented for numerous reasons. The owner or deployer of the system may feel a decision that a concept is in a subcategory is good enough evidence that it should be considered to be in a higher category. Furthermore, a forwarding category may be more understandable. For example, “/Games/Gambling/Sports/Racing” 462 may be easier to understand as “/Sports/Horse Racing.” A forwarding category may also be used if a certain category is to be “suppressed.” When a category is suppressed, the category is not included by the system in the resulting analysis. A category can be suppressed because it is determined that the system rarely gets the category correct or because it is felt that the presence of the category in an analysis could be embarrassing to a user or a company, among other reasons. For example, category “Pornography” 466 may be a suppressed category, and this status can be indicated by means of specifying a well-known “Suppressed” category 468 as its forwarding category. In alternative examples other means may be used to identify a category as suppressed.

While FIG. 4 illustrates categories as implemented through the use of programming-language objects containing references to one another, other implementations, such as, but not limited to, the use of database tables, maps, and/or parallel lists or arrays are employed in other examples.

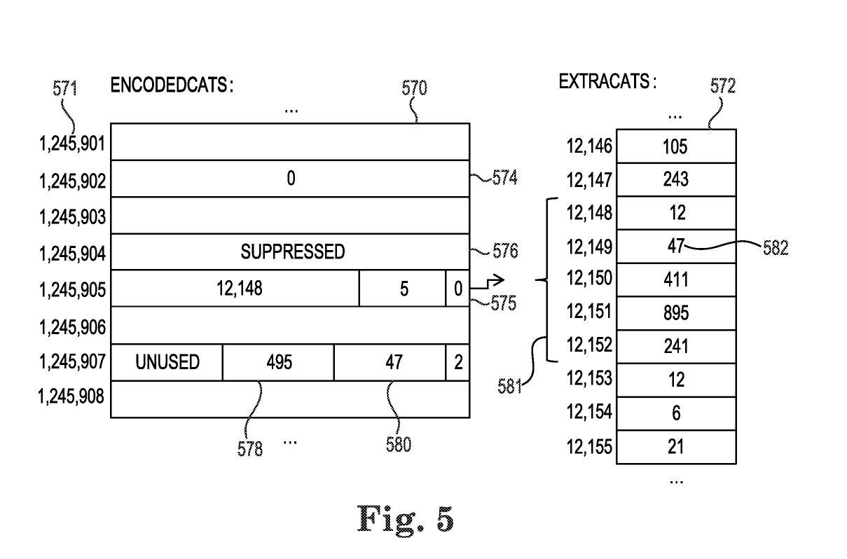

Memory-efficient mapping can occur from concepts to categories and from concepts to names using arrays. FIG. 5 is a block diagram of example arrays for use in constructing an analysis of a document according to the present disclosure. To support mapping from concepts to categories, the system can include two arrays including an encoded categories array 570 and an extra categories array 572. The encoded categories array contains 32-bit values that encode under one interpretation sufficient information to establish the categories associated with any concept associated with fewer than four categories and under another interpretation sufficient information to use the extra categories array to establish the categories associated with any concept associated with four or more categories. To determine a set of categories associated with a given concept number 571, the number can be used as an index into the encoded array 570. If a retrieved value is zero 574 or a distinguished suppressed value 576, the resulting set of associated category numbers is empty. Otherwise, the two low-order bits in the retrieved value can be used as a discriminant. If the number in the field is greater than zero, then it can be taken to be the number of associated category numbers (e.g., category numbers 578 and 580), which can be stored in 10-bit fields, right to left, in the remaining 30 bits of the retrieved value. If the number is zero 575, the remaining 30 bits can be considered as a 24-bit offset field followed by a 6-bit length field, and the category numbers (e.g., category number 47, at 582) can be given by length values taken from the extra array 572, starting at an offset value. In an example, the concept whose number is 1,245,905 has five categories associated with it, and the numbers of those categories can be found in the extra categories table starting at position number 12,148, as illustrated by bracket 581.

The sizes and layout of the fields within the entries of the arrays may vary in different examples (e.g., based on the natural word size of the machine or the virtual machine presented by the implementation language or based on the number of categories present in the system). In an example in which seven bits suffice to number the categories, it is possible to encode four categories, along with a three-bit discriminant in each entry in the encoded categories array 570, while if more than ten bits are required to identify a category, only two categories may be so encoded. In some examples, some categories (e.g. more common categories) may be represented in the retrieved value using fewer bits than less common categories. In such an example, a single-bit discriminant may be used to identify the case in which the retrieved value specifies an offset and number of categories to be retrieved from the extra categories array. The remaining 31 bits may be broken up into six one-bit fields representing the presence or absence of the six most common categories (e.g., “/Regional/United States” or “/Society/Politics”), three five-bit fields, which can encode up to three categories taken from the 31 next most common categories, and one ten-bit field, encoding up to one instance of any other category. In such a way, up to ten categories may be encoded for a concept without recourse to the extra categories array all but at most one such category is among a predetermined set of 37 categories.

To support mapping from concepts to names, and in order to decrease memory use, the system may keep the concept names in an external location such as a file and not obtain a given concept's name until the first time it is requested. However, the list of concepts may also be walked through, asking each for its name, which may cause each name to be loaded.

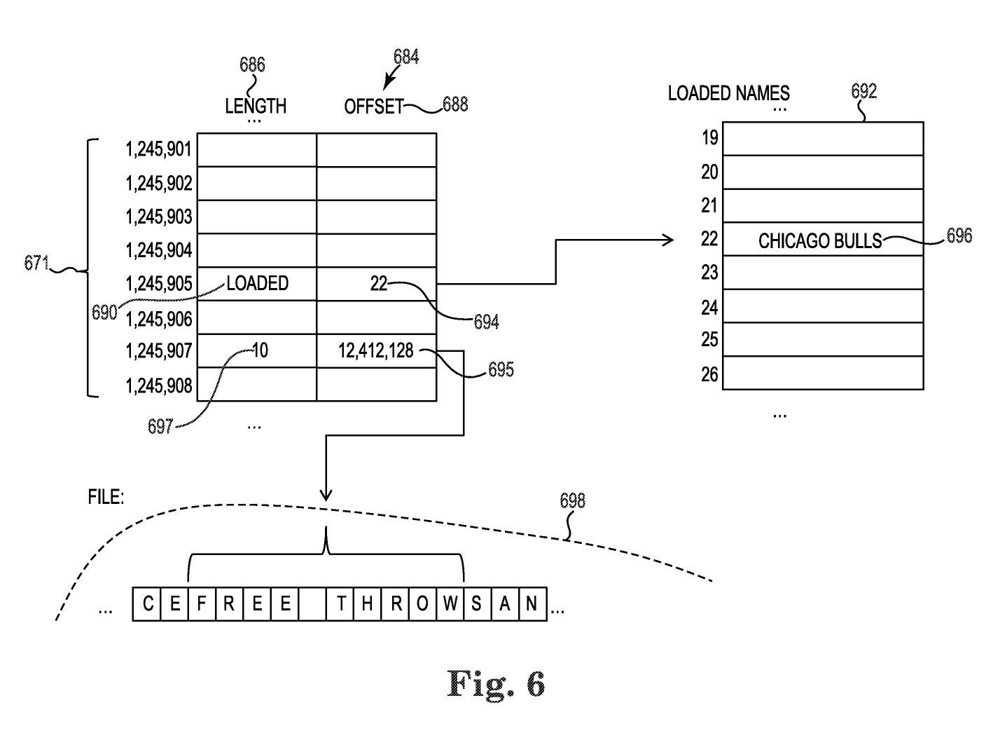

A concept class can include an offline string table to support the loading methods and the mapping from concepts to names. FIG. 6 is a block diagram of an example offline string table 684 used in constructing an analysis of a document according to the present disclosure. Offline string table 684 can include names of concepts that can be pulled into memory when required. The offline string table 684 can include two parallel arrays: an array of 32-bit numeric values 688, also known as “starts” or “offset” and an array of 8-bit numeric values 686, also known as “lengths.” The precise size of the values of the various arrays may differ in different examples. The offline string table 684 can further include a list of strings containing cached names that have been looked up, as well as a reference to a random-access file on disk. The file can contain the text of the names, optionally encoded according to the UTF-8 encoding specified by the ISO/IEC 10646:2003 standard or according to another encoding specification. To look up a name, the table's “get” method can be used, passing in the concept's number. The lengths array at the slot indexed by that number can be consulted, and if it contains a pre-determined constant value (e.g., a “loaded” value 690), the string has been loaded already, and the starts array 688 at a corresponding slot 694 can contain an index in the cache list 692 of the name (e.g., “Chicago Bulls” 696), which can be retrieved. Otherwise, the lengths array 686 can contain the number of bytes 697 in the encoding representation of the name, and the starts array 688 can contain the offset 695 in a file 698 of a character in the encoding representation. Values 671 (e.g., 1,245,901, 1, 245,902, . . . , 1,245,908) may be used for informational purposes, in order to aid a user in understanding which row corresponds to which index, and these numbers may not be stored in the table.

A byte array can be constructed, and bytes can be read from the file of the character and can be used to fill the byte array. The byte array can be converted to a string, and the result can be added to the cache 692, with the position in the cache replacing a value 695 in the start array 688. In some examples, the cache 692 further includes a “trail”, which keeps track of old values of the start 688 and length 686 arrays. When the cache 692 reaches a particular size, elements can be discarded, with the information in the trail used to undo the corresponding modifications to the start 688 and length 686 arrays, returning them to their original values.

FIG. 7 is a block diagram of an example of a parsed text object used in constructing an analysis of a document according to the present disclosure. Block 7102 includes material input to a document, and block 7104 includes a detail of a portion of a parsed text object created corresponding to it. The parsed text object contains a list of “blocks”, each of can contain a weight value indicative of a relative importance of the block and a collection of objects representing individual sentences in the block, each of which is associated with the block that contains it. When giving weight to features that are found when determining what a page is “about,” features in some blocks (e.g., a block relating to the title of a page 7106) can be worth more than those in other blocks (e.g., a block relating to the body of the page 7108 or a keywords section of the page 7110), and features in blocks with fewer sentences can be more valuable since they represent a larger fraction of the text of the block than those in longer blocks. In an alternative example, the parsed text object does not contain a list of blocks containing sentences but merely a list of sentences. In a further alternative example, each block contains a single string rather than a collection of sentences. It should be noted that “sentences” can mean sequences of characters taken from the input from which a block is created and does not necessarily imply that the sequences of characters form a grammatical sentence in any human natural language.

A JSON object can contain two keys, a “tweet” key 7112 and a “pages” key 7114. Either key can be absent. If the tweet key 7112 is present, it can refer to a string 7116 representing the text of a particular Twitter message, and a block can be made from its contents and added to a returned parsed text object. If the pages key 7114 is present, it can refer to a JSON array of JSON objects each descriptive of a particular web page. Each of these objects can contain associations optionally including “title,” 7106 “keywords,” 7110 “description,” and “body” 7108. Examples of a title 7106, keywords 7110, and text body 7108 are illustrated at blocks 7118, 7122, and 7120, respectively. Blocks corresponding to each of these can be seen as part of the corresponding parsed text object in block 7104. Block 7119 corresponding to the title 7118 has a block weight of 5, reflecting a decision that features contained within page titles are five times as important as features contained within similarly-sized other blocks. Similarly, block 7121 corresponding to the keywords 7122 has a block weight of 2.

To better support the extraction and weighting of features, the input text for a block may be split into separate sentences. This splitting may involve using a regular expression or other means to approximate the detection of human natural-language boundaries. Sentences 7124 and 7126 demonstrate two such sentences identified by splitting input text 7120. In some examples, the text of the identified sentences may be less than all of the input text for a block. Different techniques of text splitting may be employed to split different types of input text. For example, rather than splitting into an approximation of natural-language sentences, the keywords 7122 may be split as a comma-separated list resulting in the four “sentence” strings in block 7121 In some examples a piece of input text may be determined to consist of several paragraphs, sections, or other structures and multiple blocks may be created corresponding to the different parts. In some examples, markup tags, such as those used in Hyper-Text Markup Language (HTML) or Extensible Markup Language (XML) may be used to determine sentence or other structure boundaries.

In some examples, the text may be transformed before or after it is split. For example, if the text contains HTML entities, these entities may be converted into the characters or strings they encode, as replacing “&amp;” to an ampersand or “&lt;” by a less-than sign. In examples in which the input contains HTML or XML markup, such markup may be removed. In some examples text may be removed as unlikely to provide useful features. This removal may be based on the recognition of a pre-determined list of strings (e.g., “Follow us on Twitter”), by one or more patterns, or by other means.

In some examples, the body text (with or without markup) of a web page may be analyzed to distinguish text considered to be the page's actual content from text determined to be advertising, navigational links, boilerplate, links to other articles, comments, etc., with some of these classes of text being omitted from the resulting parsed text 7104. To try to distinguish content text from framing text, rules may be used to identify and omit text that is considered unlikely to represent natural language sentences. For example, a putative sentence may be omitted if it contains fewer than 20 characters or more than 500 characters or if it contains fewer than two sequences of spaces, indicative of word breaks. In some examples, there may be a number of maximum number of sentences that a block can contain or other similar limits on the amount of text processed or the number of blocks in a parsed text object.

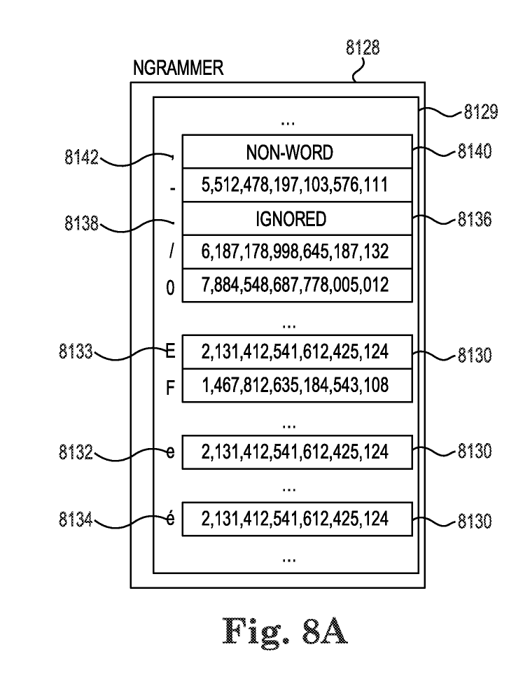

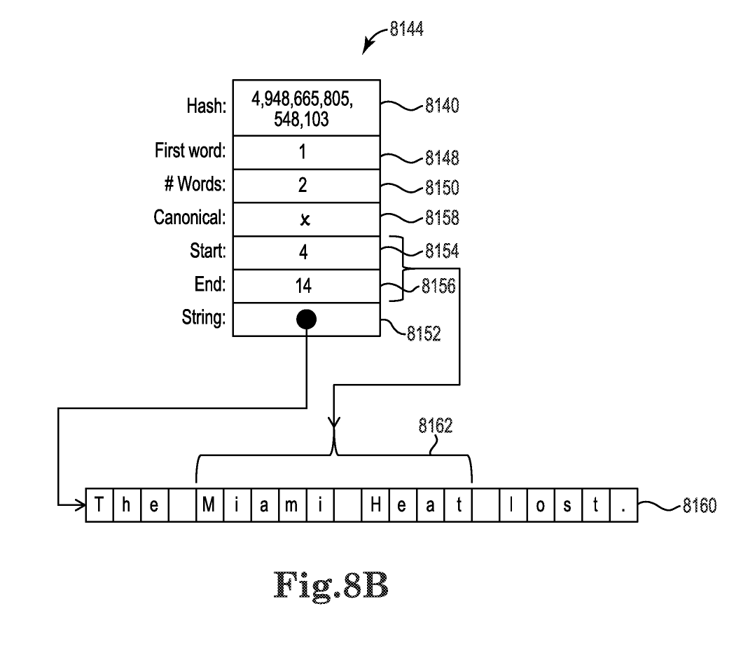

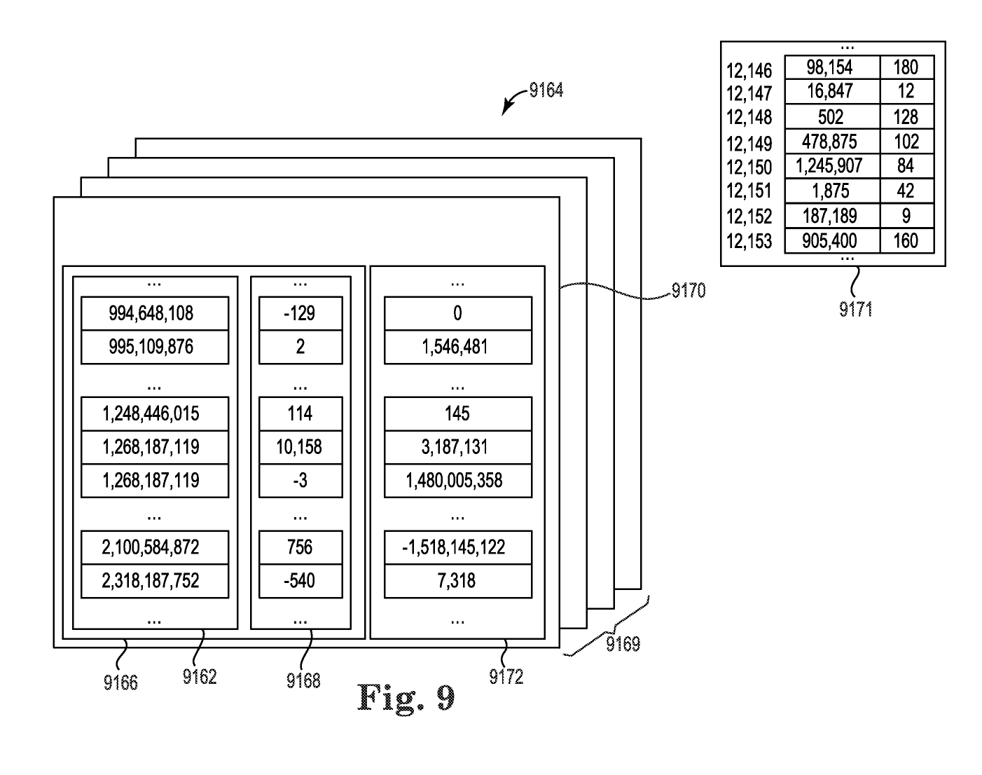

As discussed with respect to FIG. 3A, at 326, a set of features can be extracted, or identified, based on the parsed text 7104. In an example, the extraction of features is accomplished by means of enumerating short sequences of words, called “n-grams”, using data structures described with respect to FIGS. 8A and 8B and building features using data structures described with respect to FIG. 9. The n-grams are enumerated from within each of the sentences contained in the blocks of the parsed text, and the resulting features are associated with the sentences and blocks they come from.

To facilitate the efficient recognition of a very large number of potential features, each of the substrings of text represented by an n-gram is converted to a number by a hashing function. In the example, a Mapped Additive String Hashing (MASH) algorithm described in George Forman and Evan R. Kirshenbaum “Method and System for Processing Text,” U.S. application Ser. No. 12/570,309 (filed Sep. 30, 2009), and/or George Forman and Evan Kirshenbaum, “Extremely Fast Text Feature Extraction for Classification and Indexing”, CIKM '08 can be used. In other examples, strings may be used directly or other hashing methods may be used. Examples of such other hashing methods include, but are not limited to linear congruent hashes, Rabin fingerprints, and/or cryptographic hashes such as the various message digest algorithms (e.g., MD-5) or secure hashing algorithms (e.g. SHA-1).

FIG. 8A is a block diagram of an example n-grammer 8128 used in constructing an analysis of a document according to the present disclosure. FIG. 8A illustrates a block diagram of an example n-grammer 8128, used as part of the feature table (e.g., table 212) in the example, which is capable of taking an input text and enumerating n-grams representing short sequences of words within that text.

FIG. 8B is a block diagram of an example n-gram 8144 used in constructing an analysis of a document according to the present disclosure. An example of such an n-gram 8144 can be identified from input text 8160 (e.g., the text from sentence 7126 in FIG. 7). The n-gram 8144 represents the subsequence 8162 of characters within input text 8160 containing the characters “Miami Heat”. The data structure 8144 representing the n-gram contains a 64-bit hash 8146 of the characters, an indication 8148 of which word in the sentence the n-gram begins at (in the example, the first word has index zero, so “Miami” is word one), an indication 8150 of the number of words in the n-gram, indications of the starting 8154 and ending 8156 character positions in the sentence (following the normal computer science convention of representing the end by the position of the first character not included), and a reference to the input text 8144. In some examples, there is also an initially-null reference to a canonical representation 8158 of the text.

Returning now to FIG. 8A, the hashing algorithm may intentionally consider many distinct strings identical. In an example, when it is required, the n-grammer 8128 is able to choose one such representation (which may not be one that occurs in actual input text) and associate it with the n-gram, ensuring that all n-grams that have the same hash value 8146 will have equal canonical representations. Two n-grams 8144 can be considered equal if they have the same hash; string comparison is not required in n-gram comparison.

Within n-grammer 8128 in the example is a mapping array 8129 used to control the MASH hashing algorithm. The array 8129 contains one 64-bit entry for each character in the system's character set. In an alternative example, other numbers of bits may be used. Each character that is to be considered part of a word is associated with a substantially uniformly distributed number, as would be generated by a pseudorandom number generator seeded with a predetermined seed value, with the restriction that if two characters are to be considered equivalent, they are associated with the same value. In the example, uppercase and lowercase letters are considered equivalent, so the array entries associated with “E” 8133 and “e” 8132 contain the same value 8130. Similarly, the presence or absence of accent marks or other diacritics is considered insignificant, so the array entries for “e” 8132 and “é” 8134 contain the same value 8130. In the example, the characters that can be parts of words include letters, numbers, hyphens, slashes, and ampersands. Furthermore, in the example, periods 8138 are considered to be insignificant (e.g., allowing “U.S.A.” and “USA” to be treated as equivalent). This can be signaled by the presence of a predefined “IGNORED” value 8136, different from all word-character values.

Characters that are not intended to be considered as parts of words, such as commas 8142, are associated with a predefined “NON-WORD” value 8140, different from all word-character values. To enumerate all of the n-grams 8144 within an input text 8160, the n-grammer 8128 first enumerates all of the words and keeps track of their starting position, ending position, and hash. To detect and compute the hash for a word using the MASH algorithm, a 64-bit accumulator can be initialized to zero. For each character in the input text, the character is looked up in the mapping array and the associated mapped value is noted. If the mapped value is the NON-WORD value 8140 or if there are no more characters, the current word, if any, has ended. If the accumulator has a value of zero, there was no current word, otherwise, the current word is noted as a word running to the current character's position, then the accumulator is reset to zero and the current character's position is taken to be the start of the next word and the next character is processed. If the mapped value is the IGNORED value 8136, the next character is processed. Otherwise, the accumulator is modified by computing a value based on the current value of the accumulator and the mapped value (e.g., by rotating the current value of the accumulator and adding in the mapped value). Once the words are enumerated, n-grams 8144 are constructed from sequences of words up to some maximum length, where the hashes 8146 of multiword n-grams 8144 are computed by combining the hashes of the successive words they contain. In an example, this combination is performed by a different algorithm than was used to form the hashes of the individual words (e.g., by rotating the current value of the accumulator and XORing the hash of the next word).

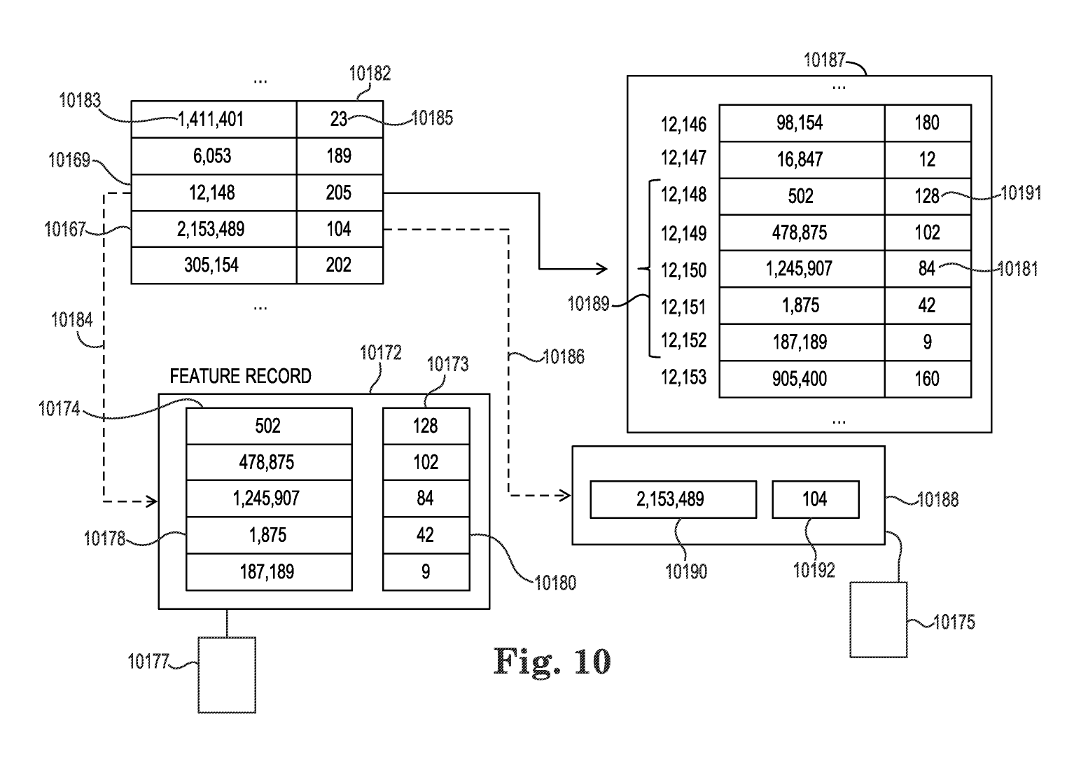

FIG. 9 is a block diagram of an example uniform map set 9164 used in constructing an analysis of a document according to the present disclosure. The data structure called a “uniform map set” 9164 as illustrated in FIG. 9 can be used in the example in the implementation of the feature table 212 (in FIG. 2). The uniform map set 9164 can provide a space- and time-efficient way to map between n-grams (e.g., n-gram 8144) and arbitrary values in some range type. For the uniform map set 9164 used in the implementation of the feature table (e.g., feature table 212), the range values can be feature records (e.g., record 10172), as described further herein with respect to FIG. 10. Uniform map set 9164 contains an array 9169 of uniform lookup tables 9170, each of which is capable of mapping from a substantially-uniformly-distributed hash integer value, and a decoder 9171, which is capable of converting between these numbers and the range type.

In alternative examples, each uniform lookup table 9170 has its own associated decoder 9171. In other examples, the uniform map set contains a single uniform lookup table 9170 used for n-grams 8144 of any length. In further alternative examples, other mechanisms are used for the implementation of a feature table (e.g., table 212). Such other mechanisms may include hash tables, associative maps, parallel arrays, b-trees, or databases.

Each uniform lookup table 9170 contains parallel arrays of keys 9166 and values 9172, where the value at a particular index in the value array 9172 corresponds to the key at the same index in the key array 9166 and the elements of the key array are stored in a sorted order. In the example, the keys 9166 are stored in ascending numeric order. A uniform lookup table 9170 provides the ability to determine whether a particular value is a key in the key array 9166, to return the index in the key array 9166 of a value if it exists there, and to return the number at a particular index in the value array 9172.

To determine the index of a number in the key array, 9166 a variant of the binary search algorithm can be used. In this variant, the probe point at each iteration is chosen to be

$$low + \frac{{H}_{target} - {H}_{low}}{{H}_{high} - {H}_{low }} ( high - low )$$

where low and high are the current bounds on the range being searched, H_{target} is the value being looked up, and H_{low} and H_{high} are the values at positions low and high, respectively, in the key array 9166. In alternative examples, binary search, linear search, or other methods may be used instead of this algorithm. In the example illustrated in FIG. 9, the key array 9166 is implemented as two parallel arrays, an array 9162 of 32-bit values containing the high-order 32 bits of the 64-bit key values and an array 9168 of 16-bit values containing the subsequent 16 bits of the 64-bit key values. In alternative examples, other numbers of bits are chosen to implement these arrays. To look up a target value, the search algorithm described above can be performed with respect to the high-order 32 bits of the target value and the high-order-bits array 9162. If a value is found, the corresponding entry in the subsequent-bits array 9168 can be compared with the subsequent 16 bits of the target value. If they are the same, a match has been found. Otherwise, a linear scan is made in both directions checking other values in the subsequent-bits array 9168 for which the high-order-bits array 9166 has a value matching the high-order 32 bits of the target value. Because of the substantial uniformity of distribution of the hashing function used, this may be expected to happen very infrequently for suitably-chosen array widths. In FIG. 9, entries in key array 9166 at 9165 and 9167 each have high-order bits equal to 1,268,187,119, and so the corresponding entries, 9163 and 9161 in the subsequent-bits array 9168 must be consulted in order to distinguish them.

To look up an n-gram (e.g., n-gram 8144), the uniform map set 9164 can obtain the number of words (e.g., 8150) in the n-gram (e.g., n-gram 8144) and can use that in an index into its array of uniform lookup tables. If a corresponding uniform lookup table 9170 exists, it then asks the uniform lookup table 9170 to lookup up the n-gram's hash (e.g., hash 8146). In this manner, it can determine whether it contains an entry corresponding to the n-gram (e.g., n-gram 8144) and it can also use the index returned by the uniform lookup table 9170 to at that time or later retrieve the value associated with the n-gram (e.g., n-gram 8144). To retrieve the value, it identifies the uniform lookup table 9170 associated with the n-gram's (e.g., n-gram 8144) number of words 8150, and obtains from that uniform lookup table 9170 the numeric value associated with the index. It then uses the decoder 9171 to convert this numeric value into a value in the uniform map set's 9164 range type.

After the n-grams (e.g., n-gram 8144) are enumerated by the n-grammer (e.g., n-grammer 8128), they are looked up in the feature table's (e.g., feature table 212) uniform map set 9164. For any which are found, a feature is created, which contains the n-gram (e.g., n-gram 8144) and the index corresponding to the n-gram (e.g., n-gram 8144) in the corresponding uniform lookup table 9170 in the uniform map set 9164. In the example, these features are associated with the sentences within the parsed text (e.g., text 7104) they are found in to form the feature set extracted at 326 in FIG. 3A.

Each feature is associated with a mapping, which can be referred to as a feature record, that maps between concepts and probabilities and gives an estimate of the likelihood that an occurrence of a given feature should be taken as implying the existence of a reference to a given concept. Such an estimate may be made based on the fraction of times the corresponding text was used in a given corpus in a way determined to be a reference to the concept. In an example, the underlying corpus is Wikipedia and concepts are identified with Wikipedia articles, the estimate may be based on the fraction of times that the text associated with the feature, when occurring within Wikipedia, is contained within a hyperlink that points to the article associated with a particular category.

FIG. 10 is a block diagram of an example of feature records 10188 and 10172 used in constructing an analysis according to the present disclosure. Feature records 10188 and 10172 are associated respectively with features 10175 and 10177, which have the same number of words. Value array 10182 is an example of the value array 9172 in the uniform lookup table 9170 associated with both features 10175 and 10177, where the value associated with feature 10175 is found at 10167 and the value associated with feature 10177 is found at 10169. In FIG. 10, the 32-bit numeric items in value array 10182 are interpreted as a 24-bit concept/offset value (e.g., value 10183) and an 8-bit probability/length value (e.g., value 10185). In alternative examples, other bit-field layouts may be used.

When creating the feature record for feature 10175, a value 10167 is retrieved from the uniform map set (e.g., uniform map set 9164) and interpreted by a decoder 10187 (e.g., decoder 9171 as illustrated in FIG. 9) as a concept/offset value of 2,153,489 and a probability/length value of 104. The probability/length value is compared to the threshold value of 200, and since it is less than or equal to 200, is interpreted as a probability value, with the concept/offset value interpreted as a concept value. The decoder then constructs feature record 10188 with an internal concept array 10190 containing a single concept, number, 2,153,489, and a parallel internal probability array 10192 containing a single probability represented by the number 104, which is the actual probability multiplied by a multiplier of 200.

To interpret a probability value, the probability value is divided by the multiplier, so the probability in feature record 10188 is interpreted as being 52%. In alternative examples either the threshold value or the multiplier may be numbers other than 200 and they may differ from one another. In alternative examples the mapping between concepts and probabilities may be implemented in different ways, including, without limitation, having the internal concept array 10190 contain references to concept objects rather than concept numbers, having the probability array 10192 contain probability numbers directly rather than multiplied by a multiplier, using a single array of mapping objects, using lists rather than arrays, using a map or hash table rather than parallel arrays, or using a specialized object for the case in which there is only a single concept in the mapping.

When creating the feature record for feature 10177, a value 10169 is retrieved from the uniform map set (e.g., uniform map set 9164) and interpreted by the decoder as a concept/offset value of 12,148 and a probability/length value of 205. Since the probability/length value is greater than the threshold value, the threshold value is subtracted from it and the result, 5, is interpreted as a length value, with the concept/offset value being interpreted as an offset value. The decoder then uses the offset value as an index into its concept probability table 10191 and considers the range 10189 of entries starting at this index and extending based on the length value as referring to feature 10177.

The entries in the concept probability table are interpreted as concept values and probability values as described above. In some examples, probability values are constrained to be less than or equal to the threshold value, while in alternative examples, entries with probability values greater to the threshold value are interpreted recursively as offset values and length values and the corresponding sequences of concepts and probabilities are interpolated. The decoder creates feature record 10172 with an internal concept array 10174 containing concept values from the entries in the range and a parallel internal probability array 10173 containing probability values (e.g., 84, at 10181) from the entries in the range. When interpreting the mapping, each numbered concept mentioned is implied with the probability indicated by the corresponding probability value. For example, concept 1,875 in box 10178 is implied by feature 10177 with a probability of 24%, computed by taking the number 42 in box 10180 and dividing by the multiplier, 200. In the example, the parallel concept and probability arrays are ranked by probability, with the most probable association listed first. In alternative examples, the arrays are in some other order or in no particular order. In further alternative examples, the concept probability table in the decoder does not ensure that the resulting ranges will be in the correct order and the decoder sorts the arrays to put them in the proper order.

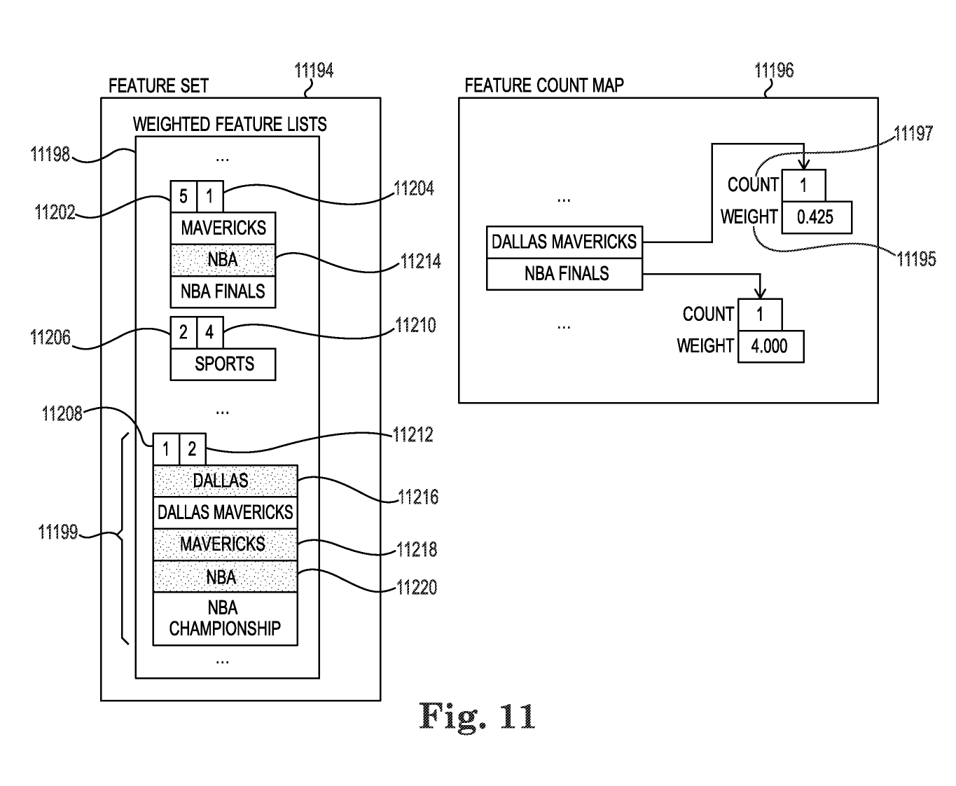

FIG. 11 is an example of a feature set 11194 and a feature count map 11196 used in constructing an analysis of a document according to the present disclosure. Feature set 11194 includes a collection 11198 of weighted feature lists (e.g., weighted feature list 11199), which represent collections of features taken from the same sentence (e.g., sentence 7124 in FIG. 7) from an input parsed text object (e.g., input parsed text object 7104) along with an indication of the block weight (e.g., weights 11202, 11206, and 11208) and block length (e.g., number of sentences) (e.g., lengths 11204, 11210, and 11212) of the block containing the sentence.

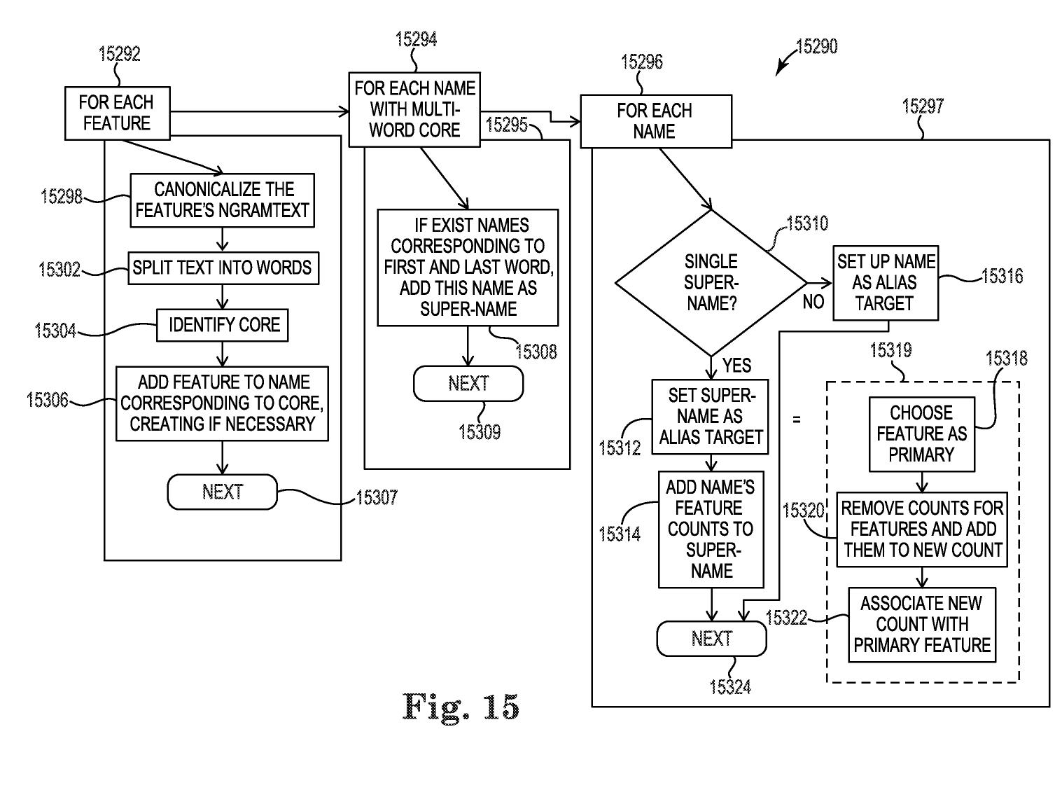

In addition to being able to enumerate its features, a feature set 11194 can return a feature count map (e.g., as illustrated at 332 of FIG. 3A) 11196 from a feature to a count, wherein a count is an object that contains a count 11197 of the number of times a given feature appears in the feature set 11194 and a weight 11195. The weight can be computed as the sum of the “sentence weights” of each of the sentences that each occurrence of the feature appears in. The sentence weight can be computed as

$$w ( 0.05 + \frac{0.75}{l} )$$

where w is the block weight, l is the block length of the block of sentence sets that the sentence appears in, and the constants are chosen to give a minimum sentence weight of 0.05w for a sentence in a very long block and maximum sentence weight of 0.8w for a sentence in a one-sentence block. In alternative examples, other functions and constants can be used to determine sentence weights. In some alternative examples, different blocks (e.g., blocks created as the result of processing different parts of the input object 7102) may compute sentence weights by different means. In some alternative examples, different sentences within the same block may be associated with sentence weights computed by different means. For example, the first sentence in a block may have constants chosen to weight it higher than subsequent sentences in the block. Alternatively, the function for computing the sentence weight may take into account the ordinal position of the sentence in the block or the block in the parsed text object (e.g., object 7104). In some examples, when constructing a feature count map 11196, some features (e.g., features designated as “filter only”, as described below with respect to FIG. 15) may be omitted. In some examples, when a feature count map 11196 is constructed from a feature set 11194, the feature set 11194 remembers the feature count map 11196 and returns it on subsequent requests for the feature count map 11196. In some such examples, operations that modify the feature set 11194 (e.g., removing overlapping features at 330 in FIG. 3A) cause the feature set 11194 to forget any remembered feature count map 11196 and will cause the feature count map 11196 to be recomputed if requested.

FIG. 12 is a block diagram of an example constructed analysis object 12222 (e.g., as constructed in FIG. 3A at 337) according to the present disclosure. In the example, analysis object 12222 includes an evidence map 12228, which associates category paths (i.e., associations between categories and concepts) with evidence supporting the category paths' relevance to a description of the document. Analysis object 12222 further contains a set 12230 of categories that are deemed (e.g., by category path filter 218 at 340 in FIG. 3A) to have sufficient support to likely not be mistakes. Analysis object 12222 further contains a categorization 12226, which contains an association between a set of categories and a numeric value indicative of the categories' relevance to the document (e.g., as determined by categorizer 220 at 328 in FIG. 3A). In some examples, analysis object 12222 further contains a scale factor 12224, to be used in interpreting and making use of the evidence map 12228. In some examples, the analysis object may also contain a feature set 12234 (e.g., feature set 11194), a parsed text object 12232 (e.g., parsed text object 7104), and/or a filter result object 12236, descriptive of how feature set 12234 was filtered (e.g., by feature filter 222 at 334 in FIG. 3A). In alternative examples, the information contained in an analysis object 12222 may be different or configured substantially differently. For instance, rather than include scale factor 12224 and/or set 12230 of categories, which are of use in interpreting evidence map 12228 and/or categorization 12226, analysis object 12222 may contain a modified evidence map 12228 and/or categorization 12226, reflecting changes that would have been implied by scale factor 12224 (e.g., adjusting scores in evidence map 12228) and/or set 12230 of categories (e.g., removing category paths from evidence map 12228 and/or categories from categorization 12226). In some examples, categories (and, therefore, category paths) may not be used. In such examples, analysis object 12222 may not contain either categorization 12226 or set 12230 of non-spurious categories and evidence map 12228 may associate concepts (rather than category paths) with evidence. Constructing an analysis of a document will be further discussed herein.

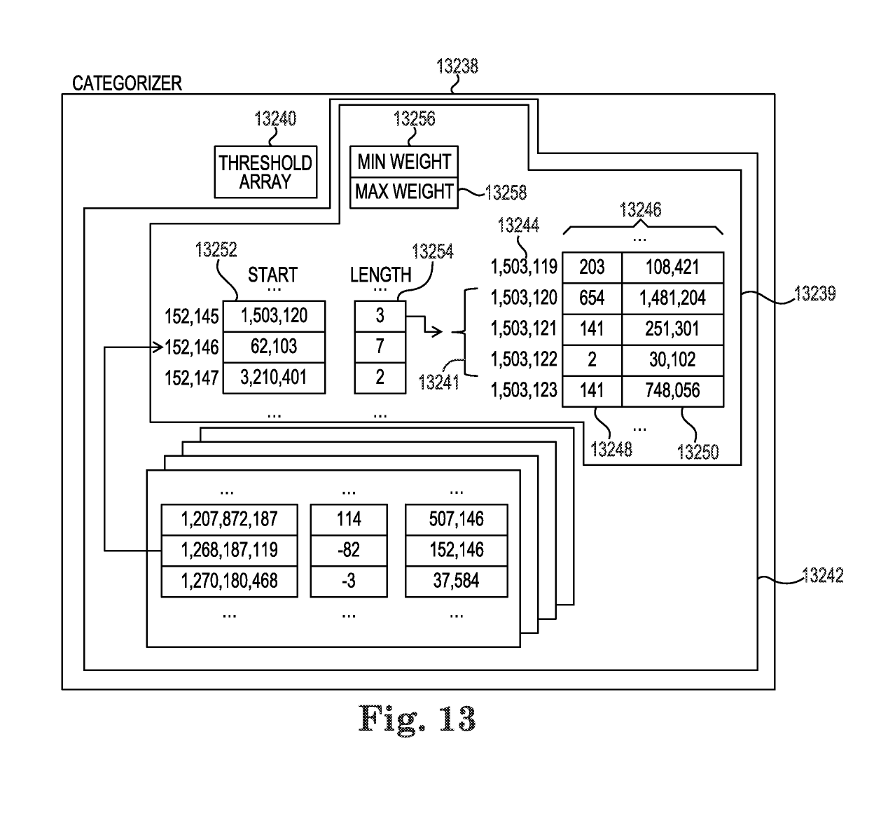

FIG. 13 is a block diagram of an example of an implementation of a categorizer 13238 used in constructing an analysis of a document according to the present disclosure. The example implementation of categorizer 13238 (e.g., categorizer 220 in FIG. 2) used in the example to compute a categorization 12226 from the feature set 12234 at 328 in FIG. 3A. In the example, categorization 12226 contains an array of floating-point score values, each associated with the category whose category number 456 matches the index in the array. As category number zero is used for categories unknown to categorizer 13238, array slot zero in categorization 12226 is unused. In alternative examples, other means (e.g., maps, hash tables, and/or parallel arrays) may be used to associate categories with score values.

In the example, categorizer 13238 contains an array of category score thresholds 12240, one per category with non-zero category number. In alternative example, categorizer 13238 may contain a single category score threshold used for all categories or such a category score threshold may be used implicitly. In further alternative examples, there may be several classes of categories, with categorizer 13238 containing or implicitly using different category score thresholds for categories in different classes. For example, there may be one category score threshold value used for all categories deemed to be regional categories and second category score threshold value used for all categories deemed to be non-regional categories.

From a categorization (e.g., categorization 12226), and in alternative examples from categorizer 13238, it may be possible to obtain a measure for a category, based on the score value associated with the category by the categorization (e.g., categorization 12226) and the category score threshold associated with the category by categorizer 13238, of a degree to which the score value exceeds the category score threshold. In an example, this measure is the ratio of the score value to the category score threshold. In alternative examples, other measures may be used, including, without limitation, the arithmetic difference between the score value and the threshold, the arithmetic difference or ratio of a numerically-adjusted (e.g., by taking a logarithm or other function) score value and the threshold, and considering the threshold value as a mean in a Gaussian probability distribution, and computing a cumulative density function of this probability distribution up to a point specified by the score value.

The categorizer 13238 can also include a uniform map set 13242 that maps features to weight sets, where a weight set is an association between categories in a subset of the set of categories and floating-point weights indicative of the likelihood that a document containing a given feature should be considered to be described by a given category. The uniform map set 13242 may be implemented in the same manner as the uniform map set 9164 associated with feature table 212, described above with respect to FIG. 9. In some examples, the number of bits used to represent a key in uniform map set 13242 may differ from the number of bits used to represent a key in uniform map set 9164.

In the example, a decoder 13239 associated with uniform map set 13242 contains an array 13246 of encoded weights, an array 13252 of offsets (or “starts”) into the array 13246 of encoded weight associations, an array 13254 of lengths of ranges within the array 13246 of encoded weight associations, a minimum weight 13256, and a maximum weight 13258. To construct a weight set associated with a given feature, that feature's n-gram is looked up in uniform map set 13242, which results in a numeric value being converted to a weight set by the decoder. To do this in the example, the decoder treats the numeric value as an index into both the array 13252 of offsets and the array 13254 of lengths, which together reference values that define a range 13241 of entries in the array 13246 of encoded weight associations. The entries in this range are then interpreted as a bit-field containing a category number 13248 and a bit-field containing an encoded weight 13250. The encoded weight may be the desired weight scaled such that a first threshold encoded weight (e.g., the maximum possible encoded weight 13250) value corresponds to a first threshold weight (e.g., the decoder's maximum weight 13258), and a second threshold encoded weight (e.g., the minimum possible encoded weight 13250) corresponds to a second threshold weight (e.g., the decoder's minimum weight 13256). The weight may be determined by dividing the encoded weight 13250 by a scale factor equal to the difference between the threshold encoded weights (e.g., maximum 13258 and minimum 13250 possible encoded weights) divided by the difference between the threshold weights (e.g., maximum weight 13257 and the minimum weight 13256) and then adding in the second threshold weight (e.g., minimum weight 13256).

In an alternative example, the decoder contains the scale factor rather than the first weight (e.g., maximum weight 13256). In alternative examples, the decoder may use other means to represent the mapping between features and weight sets and/or between categories and weights within a weight set. In some alternative examples, rather than using an array 13246 of encoded weight associations, the decoder may use two parallel arrays of category numbers (or other means of referring to categories) and weight values (or values from which weight values may be determined). In some alternative examples, the decoder may contain a single array containing references to objects, each of which contains information sufficient to create or identify a single weight set.

To compute the categorization (e.g., categorization 12226) in the example, categorizer 13238 first creates a new categorization (e.g., categorization 12226) with each category in the categorization (e.g., categorization 12226) associated with a category score of zero. In alternative examples, other initial values may be used and these values may differ from category to category. A feature set (e.g., feature set 12234) is then asked to create a feature count map (e.g., map 11196, as described above with respect to FIG. 11), summarizing the number of times each feature in feature set 12234 was seen in a parsed text object (e.g., parsed text object 7104) along with a feature weight (e.g., the sum of the block weights associated with the sentences such occurrences appeared in) indicative of the distribution of occurrences of the feature in the parsed text object (e.g., parsed text object 7104). For each feature in the feature count map (e.g., map 11196), an adjusted feature weight is computed by normalizing the feature weight associated with the feature in the feature count map (e.g., map 11196) with respect to all of the features in the feature count map (e.g., map 11196). In the example, this adjustment takes the form of computing the “L₂ norm” of the feature weight, which can be obtained by dividing the square of the feature weight by the sum of the squares of the feature weights associated with all features in the feature count map (e.g., map 11196) and then taking the square root.

In alternative examples, other forms of adjustment, including taking dividing by the sum of the feature weights associated with all features in the feature count map (e.g., map 11196), or no adjustment may be used. In alternative examples, the feature count associated with each feature in the feature count map (e.g., map 11196) may be used instead of the feature weight. The weight set, if any, associated with the feature is then obtained from uniform map set 13242. If an associated weight set exists, for each category in the weight set, the associated weight is multiplied by the adjusted feature weight and the resulting value is added to the score associated with the category in the categorization (e.g., categorization 12226). In alternative examples, other methods of categorization may be used to create the categorization (e.g., categorization 12226) including, without limitation, Naïve Bayes methods, Term Frequency*Inverse Document Frequency (TF*IDF) methods, and Support Vector Machines (SVM) methods.

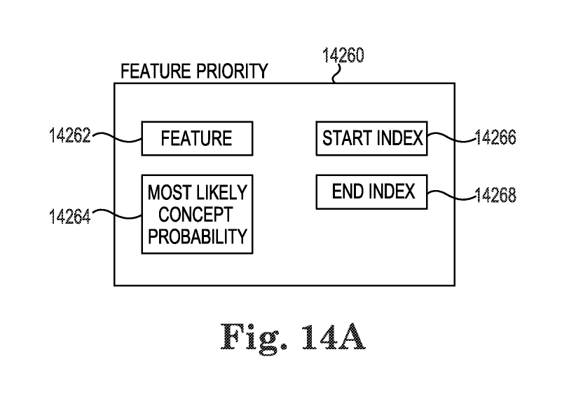

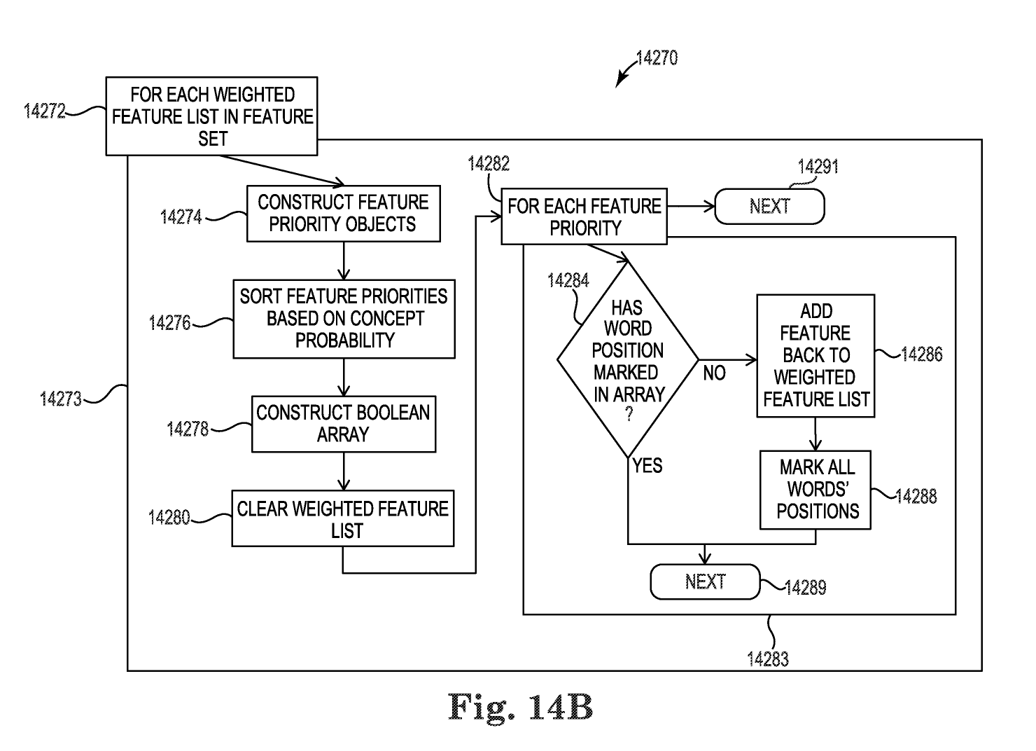

The feature set (e.g., set 11194) may include features that textually overlap. For instance, a sentence containing, “Barack Obama's cabinet” may have features matching “Barack,” “Obama,” “Barack Obama,” and “Obama's cabinet.” In some examples, it is desirable to remove features from the feature set (e.g., set 11194 and at 330 in FIG. 3A) to ensure that each word in the text of the document is part of at most one feature in the feature set (e.g., set 11194). This can be done through prioritization of the features. In the example shown in FIGS. 14A and 14B, the features chosen to be retained in the feature set (e.g., set 11194) are be those for which a user is most confident of the features' associated concepts. When confidence levels for overlapping features are the same, the preference is for the feature with the greatest number of words in the text, and when that too is the same, the preference is for the feature that starts furthest toward the beginning of the sentence. This reflects a preference for features which (in decreasing order of importance) are less ambiguous, longer, and earlier in the sentence.

FIG. 14A is a block diagram of an example feature priority object 14260 used in constructing an analysis according to the present disclosure. For each weighted feature list in a feature set, an array of feature priority objects is constructed. A feature priority object (e.g., feature priority object 14260) can include a reference to the feature 14262, indices of words the sentence that start (e.g., start index 14266) and end (e.g., end index 14268) the feature's n-gram, and an indication of the relative probability 14264 of the most likely concept for the feature, taken from the feature's feature record. In some examples, this probability indication 14264 is the probability of the most likely concept as computed by or based on the feature record. In alternative examples, the probability indication 14264 is the probability value (e.g., probability value 10192 in FIG. 10) associated in the feature record with the most likely concept (e.g., not scaled to a floating-point number by dividing by 200). In examples in which the concept array (e.g., array 10174) and probability array (e.g., array 10180) within the feature record are sorted by relative probability, the probability associated with the most likely concept will be the first value in the probability array 10180.

FIG. 14B is a flow chart of an example method 14270 for removing overlapping features from a feature set (e.g., set 11194), as used in constructing an analysis of a document according to the present disclosure. At 14272, each weighted feature list in the feature set is considered and loop 14273 is performed, focusing on that weighted feature list. At 14274, an array of feature priority objects is constructed, with one feature priority object for each feature in the current iteration's weighted feature list. The array is sorted at 14276 so that feature priority objects associated with more preferred features (as described above) appear earlier in the. At 14278, an array of Boolean is constructed, with all of its slots initialized to the false value. A slot in this array will have a true value if the word at that position in the sentence is part of a feature that has been chosen to be retained. In some examples, the length of this array will be based on the highest value of the end index 14268 of any feature priority object 14260 in the array. At 14280, the weighted feature list is cleared, by removing all of its features, in preparation for adding only the features chosen to keep.

At 14282, each feature priority object 14260 in the array is considered and loop 14283 is performed, focusing on that feature priority object 14260. At 14284, slots are checked corresponding to positions from the start index 14266 to the end index 14268 exclusive of the feature priority 14260, reflecting the positions of the words of the feature 14262 associated with the feature priority object 14260. If any of these array slots contain true values, a more-preferred feature has been chosen that overlaps with the feature 14262 associated with the current feature priority object 14260, and control passes to block 14289 and the next iteration of loop 14283. In this way, such a feature is removed from the weighted feature list since it was removed at 14280 and not added back. If none of the slots contain true values, the feature 14262 associated with the current feature priority object 14260 is added back to the weighted feature list at 14286, and each slot in the array considered at 14284 is set to a true value at 14288. Control then passes to block 14290 and the next iteration of loop 14283. When there are no more feature priority objects 14260 in the array, loop 14283 terminates and control passes to block 14291 and the next iteration of loop 14273.

FIG. 15 is a flow chart of an example method 15290 for filtering and merging features according to the present disclosure. A feature count map can be computed (e.g., at 332 in FIG. 3A) and processed by a feature filter (e.g., feature filter 222) to remove features from the feature count (e.g., when it determines that evidence seen for the feature does not support a belief that the feature is present) or merge evidence from one feature into that associated with another (e.g., when it determines that there is sufficient evidence to believe that the first feature may more profitably be considered to be the second), as illustrated in FIG. 3A at 334.

For example, an article may use a person's full name once (e.g., “Michelle Obama”), and then switch to using a shorter form (e.g., “Obama”) as the article progresses. In this example, a page about Michelle Obama may have one or two mentions of “Michelle Obama” and twelve mentions of “Obama,” both of which would show up as features. However, the feature “Obama” on its own may be considered by the system to be more likely to refer to Barack Obama than to Michelle Obama. This may lead the concept extractor (e.g., extractor 210) to erroneously conclude that a page is about Barack Obama. The feature filter (e.g., filter 222) can be used to properly identify names in text, and the feature filter can merge features that consist of a single word into longer features for which the single word is the first or last work. The feature filter (e.g., filter 222) can also merge take into account prefixes (e.g., titles) and suffixes.

For example, it may decide that references to “Mrs. Obama” should also be merged into those for “Michelle Obama”, even though the former is not a substring of the latter. The feature filter (e.g., filter 222) may also be able to determine that the feature should be discarded as being unlikely to refer to any of the concepts it knows about. For example, if a web page contains references to “Obama” and “Mr. Obama”, both recognized as features known in a feature table (e.g., table 212), the system might be led to conclude that they referred to the concept “Barack Obama”, even though “Barack Obama” is not seen. But if there is a mention of “Joe Obama” in the text, not recognized as a feature (since not in feature table 212), these features may be discarded, as they likely actually refer to Joe Obama, who is not a concept the system knows about. In some examples, the feature filter (e.g., filter 222) may be composed of multiple feature filters. In some examples, the feature filter (e.g., filter 222) may make use of information not contained within the feature count map in making its determinations.

To perform this merging of different ways of referring to named entities the example feature filter (e.g., filter 222) contains a map from strings to named entity objects representing features determined by the feature filter (e.g., filter 222) to refer to the same named entity. In the example, a named entity object contains a collection of features identified as referring to it, with one of those features identified as being its primary feature. It also contains a set of named entities identified as being its “super-names”, named entities that are longer and may refer to the same concept. It further contains an indication of whether it is a single-word named entity and, if not, its first and last words.

At 15292, each feature in the feature count map is considered and loop 15293 is performed with respect to it. At 15298, the canonical form (e.g., form 8158) of the feature's n-gram (e.g., n-gram 8144) is obtained. In the example, the canonical form is computed based on the sequence of characters covered by the n-gram (e.g., n-gram 8144) in an underlying string (e.g., underlying string 8152), and this underlying string is taken from the sentence in the parsed text object (e.g., parsed text object 7104). Initial and final sequences of characters considered to be non-word characters by the n-grammer (e.g., n-grammer 8128) in a feature table (e.g., feature table 212) are removed. Other maximal sequences of non-word characters are removed by single spaces. Characters considered to be ignored characters by the n-grammer (e.g., n-grammer 8128) are removed. Letters are converted to their lowercase forms and unaccented characters replace accented characters. At 15302, the canonical form of the n-gram (e.g., n-gram 8144) is split into words to yield an array of strings representing the individual words of the feature.

At 15304, this array of words is analyzed and a subset, which need not be proper, of these words is identified as the “core” of the feature. In an example, the array is scanned from the beginning, and each word is checked against a set (canonicalized) words considered to be prefixes, including titles (e.g., “dr”, “senator”, etc.) and articles (e.g., “the”, “a”, “an”, etc.) identifying matched words as not being part of the core until a word is found that is not in the set. In an example, the array is scanned from the end, each word is checked against a set of words (e.g., canonicalized words) considered to be suffixes, including, but not limited to, “st”, “ave”, “jr”, and/or “md”, identifying matched words as not being part of the core until a word is found that is not in the set. In such examples in which the n-grammer (e.g., n-grammer 8128) considers the apostrophe character to be a non-word character, the set of suffixes may contain “s”, to allow, e.g., “Barack Obama” to be considered to be the core of “Barack Obama's” (which canonicalizes to “barack obama s”). In some examples, processing of suffixes may stop once the scan moves to words previously identified as prefixes.

In alternative examples, words from the middle of the string (e.g., words identifiable as middle initials or nicknames) may be identified as not being part of the core. In some examples, information other than the canonical form of the words may be used to identify words to be excluded from the core. In some such examples, the underlying string (including factors such as capitalization and punctuation) may be used. The remaining words are identified as the core of the feaure. For example, “The Reverend Dr. Martin Luther King, Jr.'s” may be determined to have a core of “Martin Luther King,” and “Rev. King” may similarly be determined to have a core of “King.” In some examples, if the determined core is empty (e.g., because all words have been determined to be non-core words), the entire initial array of words may be considered to be the core. In some examples, words may be replaced by equivalent words. For example, in examples in which “&” is a possible word, it may be replaced by “and” to allow, e.g., “Tom & Jerry” and “Tom and Jerry” to be determined to have an identical core of “tom and jerry”. In some examples such substitutions may include the replacement of nicknames such as “Bobby” by more commonly official names such as “Robert”. In some examples, stemming algorithms may be used to transform words. In further examples, words or sequences of words determined to be in one language may be replaced by translations into another language

At 15306, the text of the core is used as a key to find a named entity in the feature filter's named entity map. If no such named entity is found, one may be created based on the core text and associated with the core text. The current feature is then added to the named entity's set of features, and control passes to the next iteration of loop 15293 at 15307. In some examples, when a new named entity is to be created, a check is made to see whether the first word of the core is one of a small set of words that have been found to cause problems at the beginning. Similar tests can be made for the last word being disallowed at the end and for any word being disallowed in the middle. If any of these tests pass, the named entity can be considered to have stopwords. For example, “state” may be disallowed at the end because otherwise “Washington” would be seen as an alias for “Washington State,” when these may refer to two different schools. Similarly, “west” may be disallowed at the beginning to avoid “Virginia” being seen as an alias for “West Virginia” and words like “and” and “in” may be disallowed in the middle.

When loop 15293 terminates, at 15294 for each named entity in the named entity map that is not considered to be a single-word named entity, loop 15295 is performed. At 15308, the named entity checks to see whether the named entity map contains named entities associated with either its first or last words. For any such matching named entities, the current named entity adds is added to the matching named entity's collection of super-names, and control passes to the next iteration of loop 15294 at 15309. In some examples, if the named entity has been determined to have stopwords, it does not perform the check at 15308. In some examples, the named entity keeps track of whether it has stopwords at the beginning or the end and only skips checking for named entities corresponding to its first (respectively, last) word if it has stopwords at the beginning (respectively, end). In alternative examples, the named entity may check for named entities matching longer or other sequences of words within the core of the feature that was responsible for its creation.

When loop 15295 terminates, at 15296 for each named entity in the named entity map, loop 15297 is performed. At 15310, a determination is made as to whether the named entity contains a single super-name. If this is the case, at 15312 that super-name is set up as an alias target as described below. Then, at 15314, the count objects associated in the feature count map 11196 with each of the current named entity's features are added (e.g., by adding counts and weights) to the count object associated in the feature count map 11196 with the super-name's primary feature. Finally, control passes to the next iteration of loop 15297 at 15324.

An example method for setting up a named entity as an alias target, at 15312, is shown in inset 15319. At 15318, one of the named entity's features is chosen as its primary feature. If a primary feature was previously identified for the named entity, subsequent procedures of the method may be omitted. If the named entity has only one feature, it is selected and the subsequent procedures of the method may be omitted. If there is a feature whose text exactly matches the core text which led to the named entity's creation (e.g., without prefix or suffix words having been removed and without transformation), that feature is chosen. Otherwise, the feature with the highest count value associated with it in the feature count map (e.g., map 11196) is chosen. If there is no exact match and more than one feature has the highest count value, one is chosen arbitrarily. In alternative examples, other criteria may be used for choosing the primary feature. In some examples, the chosen primary feature may not be one of the named entity's features. At 15320, a new count object is created, and the count objects associated in the feature count map (e.g., map 11196) with all of the named entity's features are added to it and removed from the feature count map (e.g., map 11196). This combines the count and weight information for all features that have a common core. At 15322, the newly-created count object is associated in the feature count map with the named entity's primary feature.

Returning to 15310, if the determination is made that the named entity does not contain a single super-name, there are two possibilities: either it contains no super-names or it contains more than one super-name. In either case, at 15316, the named entity is set up as an alias target as describe above to merge information from all features that have a common core, and control passes to the next iteration of loop 15297 at 15324. In an alternative example, when it is determined that there is more one super-name, method 15290 may attempt to identify one of the super-names as more likely, for example, by noting that one is associated with substantially higher counts than the others or by noting that one is associated with concepts or categories that have substantially more support than others.

In an example, the feature filter (e.g., feature filter 222) further builds a filter result object 12236 (as in FIG. 12) that can become part of analysis (e.g., analysis 12222). Such a filter result object (e.g., object 12236) may include information about which features were merged together or deleted and the reasons for doing so. It may be used for debugging or other purposes.

In an example of method 15290, “The Reverend Dr. Martin Luther King, Jr.”, “Martin Luther King”, “Dr. King”, “King”, and “Martin”, can all merge their information under “Martin Luther King.” Possessives, as well as names of newspapers and organizations with and without a leading “The” may be merged, as well. However, if there is an ambiguity, the merging may not take place. For example, if both “Barack Obama” and “Michelle Obama” occur in the text, a bare “Obama” may not be merged with either, and it can remain as a feature to be resolved in later processing.

In an example, the feature filter (e.g., filter 222) uses information about common names to detect situations in which features represent bare first names or bare last names (with or without attached prefixes or suffixes) that may be spurious and delete such features from the feature count set 11196. To support this, a feature table (e.g., table 212) is augmented by a uniform map set that maps from n-grams (and, therefore, features) to sets of objects of an enumerated “use class” type. Among the possible use classes may be “First Name”, for features that represent names used as first or given names, “Last Name”, for features that represent names used as last or family names, and “Initial”, for features that represent single initials.

In some examples, the “Initial” use class may be merged with the “First Name” use class. In some examples, there may be other use classes reflecting uses such as titles, suffixes, and words like “Street” (to allow for recognition that, e.g., “Lincoln Street”, if not recognized in full as a feature, should not be taken as referring to Abraham Lincoln) or “University”. Some features, such as “Frank”, which can be both a first name and a last name, may be associated with more than one use class, while many features will be associated with none. In some examples, features may be included in the feature table (e.g., table 212) solely because they are known to be in one or more use classes. To mark these, they are further associated with a “Filter Only” use class, reflecting that they should not be included in the resulting analysis. When constructing a feature count map (e.g., map 11196) from a feature set (e.g., set 11194), any features marked “Filter Only” are ignored.

When applying the feature filter (e.g., filter 222), a pass is made to identify all of the “questionable” features in the feature set (e.g., set 11194), where a questionable feature is either a (non-filter-only) feature considered to be a “Last Name” that immediately follows a feature considered to be a “First Name” or “Initial” or a (non-filter-only) feature considered to be a “First Name” or “Initial” that is immediately followed by a feature considered to be a “Last Name”. In alternative examples, other rules may be used to determine features to be questionable. To determine which features are questionable, it suffices to process all of the feature set's weighted feature lists. For each list, the features (which do not overlap, having had overlapping features removed at 330 in FIG. 3A) are sorted by their n-grams' 8144 first word 8148. The sorted list is then walked, keeping track of the current and prior feature. If the two are contiguous (e.g., as determined by the prior feature's n-gram's first word and number of words 8150 and the current feature's n-gram's first word), the above rules are checked to determine if either the current feature or prior feature should be added to a set of questionable features.

In the example, if a feature is questionable, then it—and any feature that merges with it—can be treated as spurious unless there is some extension of it that's also known to be a feature. As an example, if “Obama” is seen, it will likely be taken to refer to “Barack Obama” (unless other evidence on the page leads to another interpretation also associated in the feature table (e.g., table 212 with “Obama”). However, if “Obama”, a known last name, is seen following “Joe”, a known first name, it becomes questionable, and the system defaults to believing that its instances of “Obama” actually refer to “Joe Obama”. On the other hand, if the document also contains “Barack Obama”, then even though there was initial reason to believe that “Obama” might have been spurious, there is also reason to believe that it might not be, and so it may be left as a feature.

To implement this, at 15306, when the feature is added to a named entity, if the feature has been determined to be questionable, the named entity is marked as being questionable. Then, following 15296, another pass is made over the named entities in the named entity map. The features for any questionable named entities are removed from the feature count map (e.g., map 11196). For any such named entity that had been merged into another named entity, the counts would already have been removed, at 15320, and added into other counts, so the only ones that get removed here are those that weren't merged, which is precisely the ones that have no observed extension.

The concept extractor (e.g., extractor 200) can take the feature set's (e.g., set 11194) feature count map (e.g., map 11196) and the categorization (e.g., categorization 12226) and identify category paths that characterize the document and associate with each a set of evidence. As discussed above, a category path is an association between a category (possibly in a hierarchical category structure) and a concept. In some examples, a category path may be a determined sequence of categories paired with a concept. Such a sequence may be chosen path through the parentage hierarchy of a category, where the category hierarchy is a directed acyclic graph. A choice of concepts can be modeled as an election in which concepts are the candidates, and the goal is to choose a set which matches evidence across features seen (viewed as voters in the election each with a number of votes based on the weight associated with it in the feature count map 11196 and with votes allocated, perhaps fractionally, based on the feature record 10174 associated with it by the feature table 212). A consensus may then be found among the chosen concepts as to which categories have the broadest support. In the example, each feature ultimately chooses to support (and become evidence for) at most a single concept. In the example, the consensus also takes into account the likelihood that a candidate concept is part of the consensus based on the other concept candidates that have not yet been eliminated.

FIG. 16 is a block diagram of a neighborhood object 16632 and data structures used to construct the neighborhood object according to the present disclosure. Neighborhood object 16632 is associated with a particular concept (C) and encodes conditional likelihoods that if concept C is, in fact, mentioned in a document, then other concepts (X) will also be mentioned in the document. The likelihoods may be based on analyzing some corpus of documents (e.g., the corpus of Wikipedia articles) and noting what fraction of articles that mention concept C also mention concept X. In the case of the corpus of Wikipedia articles, in an example in which concepts are identified with Wikipedia articles, a concept may be considered to have been mentioned by an article if the article contains a link to the article identified with the concept. The set of concepts X considered to be in the neighborhood of a given concept C may be determined by a support (e.g., minimum support) threshold (e.g., only concepts X that are mentioned in at least 2 articles that mention concept C may be in the neighborhood), by a likelihood (e.g., minimum likelihood) threshold (e.g., only concepts X that are mentioned in at least 0.5 percent of the articles that mention concept C may be in the neighborhood), by a neighborhood size (e.g., maximum neighborhood size) threshold (e.g., no more than the 200 concepts X with highest conditional likelihoods may be in the neighborhood), by other considerations, or by a combination of such considerations.

In the example, neighborhood 16332 includes several parallel arrays containing information about each of its neighbor concepts, with each neighbor concept associated with a particular index. These arrays include an array of neighbor concept numbers (X) 16334, an array of neighbor probabilities 16336 conditional on the concept (i.e., P(X|C)), an array of positive likelihood ratios

$$( i . e . , \frac{P ( X \vert C )}{P ( X \vert \overline{C} )} ) 16326 ,$$

and an array of negative likelihood ratios

$$( i . e . , \frac{P ( \overline{X} \vert \overline{C} )}{P ( \overline{X} \vert \overline{C} )} ) 16328.$$

In alternative examples, the positive likelihood ratio array 16326 and negative likelihood ratio array 16328 (or their individual slot values) may be constructed as needed. In the example, neighborhood 16332 also includes a base size 16324 indicative of the relative frequency of mention of concept C, which may be based on the number of times the concept was mentioned in the corpus used to generate the neighborhood.

As neighborhood objects can be a fairly large and as there may be a large number of concepts (e.g., millions or more) known to concept extractor (e.g., extractor 200), where only a small fraction of them may be used in any given extraction, it may be beneficial to delay the construction of neighborhood objects (e.g., objects 16332) until needed. To construct neighborhood objects a number of arrays (or, in alternative examples, similar data structures) may be used. In the example, the arrays can include an array 16330 of 8-bit indicators of the approximate number of occurrences for each concept, an array 16338 of 8-bit counts of the number of neighbor concepts in a concept's neighborhood, and an array 16342 of 32-bit indices into the data array indicating where a concept's neighborhood data starts. For each of these arrays, there is one entry per known concept and the concept's number is used as the index into the array. There can also be an array 16340 of 32-bit data, parsed as 24 bits of neighbor concept number followed by 8 bits of an indicator of the approximate number of co-occurrences between the concept and the neighbor. In alternative examples, different sizes and configurations of the data in these arrays may be used and other data structures may be used to associate the needed data with individual concepts.

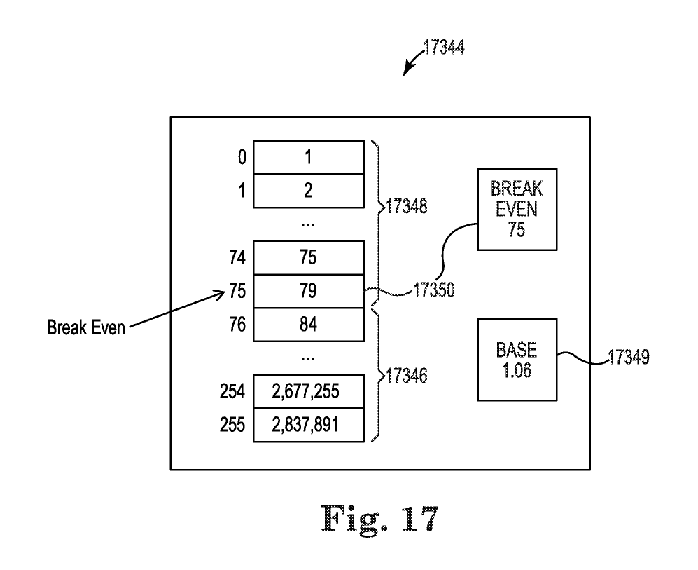

Since these arrays may be quite large, it is desirable to save memory by encoding indicators for approximate counts for the number of neighbors 16338 and the co-occurrence counts in the data 16340. In the example, these indicators are 8 bits wide and interpretable with respect to an example decode table 17344 shown in FIG. 17 to yield a value in an arbitrary range.

FIG. 17 is a block diagram of an example decode table 17344 used in constructing an analysis of a document according to the present disclosure. Approximate number indicators can be decoded by using the 8-bit indicator as an index into the array in decode table 17344, allowing an increased range to be approximated. The array in decode table 17344 can be characterized by two parameters. Below a break-even level 17350 (e.g., range 17348), each indicator refers to one more than its value (e.g., decode[0]=1, decode[12]=13). At or above the break-even level 17350 (e.g., range 17346), the decoded value can be an exponential characterized by a base 17349 (e.g., decoder[i]=baseⁱ). The break-even level 17350 can be chosen based on the base to most efficiently cover the space without wasting slots on repeated values. In the example in FIG. 17, the base is 1.06, and the break-even level 17350 implied by the base is 75, meaning that values from one to 75 can be represented exactly, and values up to approximately 2.8 million can be approximated.

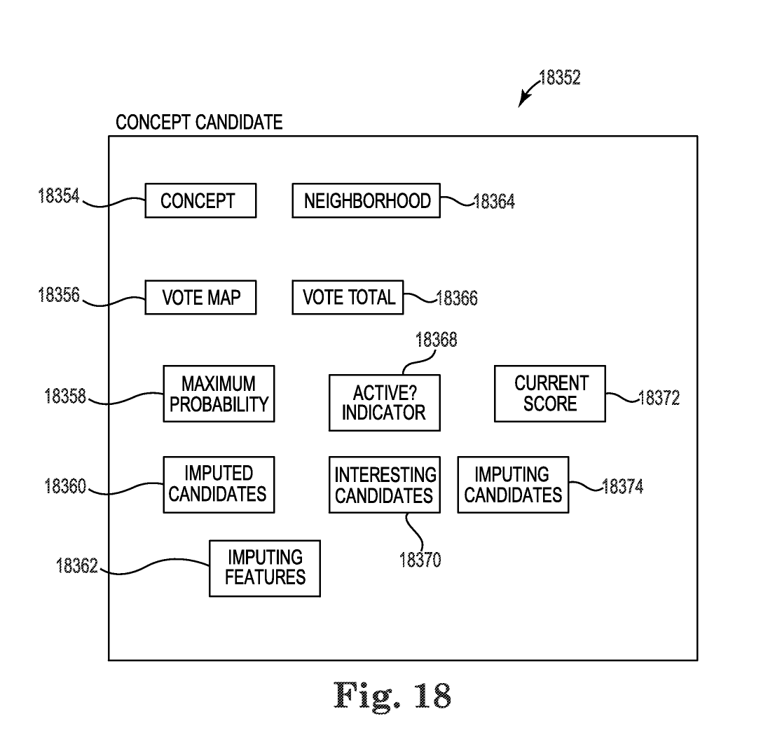

FIG. 18 is a block diagram of an example concept candidate 18352 according to the present disclosure. Concept candidate 18352 can be used in the construction of an election, and the election can be used in the construction of an analysis of a document. The election can include a set of concept candidates as well as an association (e.g., a map) between concepts and candidates that represent them. In the example, the concept candidate 18352 contains an associated concept 18354, the neighborhood 18364 (e.g., neighborhood 16332) associated with concept 18354, a “vote map” 18356 mapping between features that have voted for the concept candidate and information about the features' respective votes (e.g., the weight of the vote and the probability associated in the voting feature's feature record 10174 with the candidate's concept 18354), a total vote weight 18366 (e.g., computed as the sum of the weights of the votes in the vote map), and a maximum probability 18358 associated with any of the votes in the vote map.

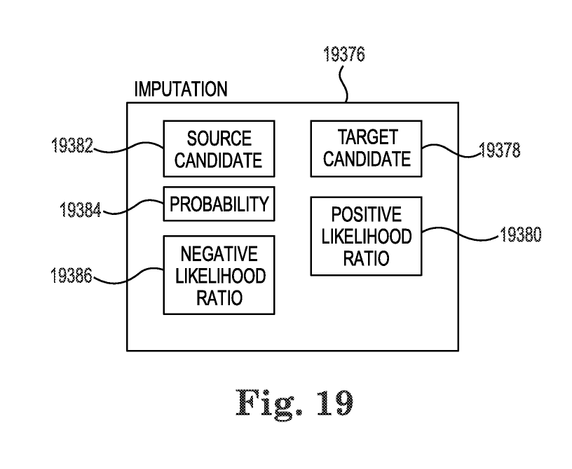

The concept candidate also contains an indicator 18368 of whether the candidate is considered to still be “active” in the election and a current score 18372, indicative of a level of belief given current evidence that the candidate's concept 18354 is mentioned in the document. The concept candidate further contains a set of imputations (discussed below with respect to FIG. 19) representing “imputed candidates” 18360 (i.e., those imputations representing concept candidates being imputed by this candidate), a set of imputations representing “imputing candidates” 18374 (i.e., those imputations representing this candidate being imputed by other candidates and contained in the other candidates' imputed candidates set 18360), a set of “interesting candidates” 18370 (i.e., further imputations representing concept candidates being imputed by this candidate, but not reflected in those candidate's “Imputing candidates” sets 18374), and a multiset (i.e., a collection in which elements may appear more than once) of “imputing features” 18362 (i.e., the features voting for the candidates at the source of imputations in the imputing candidates set 18374). In the example, a concept candidate is considered to be active if (and whenever) at least one of its vote map 18356 and its imputing candidates set 18374 is non-empty.

Alternative examples may omit some of these components. In particular, examples that do not make use of inter-concept probability, as discussed above with respect to FIG. 16, may omit neighborhood 18364, imputed candidates 18360, imputing candidates 18374, interesting candidates 18370, and imputing features 18362, as well as uses of them in methods described elsewhere. In further alternative examples, the set of concept candidates may be replaced by mappings between concepts and the various logical components of the concept candidates associated with them.

FIG. 19 is block diagram of an example imputation 19376 used in selecting a set of winning concept candidates according to the present disclosure (e.g., at 334 in FIG. 3B). An imputation can be based on a neighborhood (e.g., neighborhood 16332) associated with a concept C and can represent information taken from the arrays in that neighborhood at one particular index (e.g., associated with one particular other concept X). It contains a source candidate 19382 (e.g., the candidate associated with concept C) and a target candidate 19387 (e.g., the candidate associated with concept X) as well as a probability 19384, positive likelihood ratio 19380, and negative likelihood ratio 19386 reflective of information in the neighborhood's (e.g., neighborhood 16332) conditional probabilities array (e.g., array 16336), positive likelihood ratios array (e.g., array 16326), and negative likelihood ratios array (e.g., array 16328). In alternative examples, the imputation 19376 does not contain some or all of this information but merely contains information that allows this information to be computed. In some such examples, the imputation 19376 contains the index of the target concept within the neighborhood (e.g., neighborhood 16332). The imputed probability of an imputation is a measure of the likelihood that the concept associated with the target candidate 19378 is mentioned in a document. In the example, the imputed probability is computed as the product of the current score (e.g., score 18372) associated with the source candidate 19382 and the probability 19384.

FIG. 20 is a flow chart of an example method 20388 for setting up an election based on a feature count map (e.g., map 11196 and at 342 in FIG. 3B) according to the present disclosure. At 20390, for each feature in feature count map (e.g., map 11196), loop 20391 is performed. At 20392, the feature record (e.g., record 10174) associated with the current feature is obtained. At 20394, for each associated concept (and corresponding probability) in the feature record (e.g., record 10174), loop 20395 is performed. At 20396, the concept candidate (e.g., candidate 18352) associated in the election being constructed with the current concept is obtained (and, if necessary, created), and a vote is added to that candidate from the current feature, where the weight of the vote is the current features associated weight in the feature count map (e.g., map 11196) multiplied by the current associated probability. Control then passes to the next iteration of loop 20395 at 20401-2. In alternative examples, other rules are used to determine the weight of the vote. For instance, in some examples, the vote may not be based on the feature's associated weight. In some examples, concept candidates associated with fewer than all concepts associated with a feature may receive votes from that feature. When loop 20395 terminates, control passes to the next iteration of loop 20391, at 20401-1.

When loop 20391 terminates, at 20398, for each candidate currently in the election, loop 20399 is performed. In some examples, this is performed by enumerating based on a copy of the set of candidates to ensure that only candidates created during loop 20391 are considered. In some examples, consideration for each candidate at 20398 may be omitted.

At 20402, for each of the first ten concepts in the neighborhood 18364 associated with the current concept candidate (e.g., candidate 18352), loop 20403 is performed. In alternative examples, different numbers of neighboring concepts are used, including all concepts. In some examples, the number of concepts used, when less than all concepts, is different for different current concept candidates. At 20408, an imputation (e.g., imputation 19376) is created based on the current candidate, the neighboring concept, and information associated with the neighboring concept in the current concepts neighborhood (e.g., neighborhood 18364). This imputation (e.g., imputation 19376) refers as its target candidate (e.g., candidate 19378) to the candidate associate with the neighboring concept. If no such candidate exists in the election, one may be created.

Such a newly-created concept candidate will necessarily have no votes from features. In some examples, if no such candidate exists, no imputation is created and control passes to the next iteration of loop 20403. The imputation (e.g., imputation 19376) is added to the current candidate's (e.g., candidate 18352) imputed candidates (e.g., candidates 18360). At 20410, the imputation (e.g., imputation 19376) is added to the imputation's target candidate's (e.g., candidate 19378) imputing candidates (e.g., candidates 18374). At 20412, the features voting for the current candidate (e.g., in the current candidate's vote map 18356) are added to the imputation's target candidate's imputing features (e.g., features 18362). Since the imputing features (e.g., features 18362) are, in the example, a multiset, adding features that already exist in the imputing features (e.g., features 18362) will increase the number of times that they are represented. Control then passes to the next iteration of loop 20403 at 20413.

When loop 20403 terminates, at 20404, for each of the remaining concepts in the neighborhood (e.g., neighborhood 18364) associated with the current concept candidate (e.g., candidate 18352), loop 20405 is performed. In some examples, fewer than all of the remaining neighboring concepts are enumerated. In some examples, consideration for remaining neighbors at 20404 is omitted. At 20406, substantially the same processing takes place as at 20408, but rather than being added to the set of imputed candidates (e.g., set 18360), the created imputation (e.g., imputation 19376) is added to the set of interesting candidates (e.g., set 18370). In this example, loop 20405 does not contain analogues of adding an imputation to a target's imputing candidates at 20410 or adding voters to a neighbor's imputing features at 20412. Control then passes to the next iteration of loop 20405 at 20407. When loop 20405 terminates, control passes to the next iteration of loop 20399 at 20400.

Allowing imputed candidates without feature support can permit candidates to hypothesize a context that could have been mentioned, but was not, or hypothesize a context that was not mentioned in a manner recognizable by the feature table (e.g., table 212). For example, the concepts for Jack Brickhouse, a Chicago Cubs announcer, and Kerry Woods, a later Chicago Cubs player, may not refer to one another in their respective neighborhoods (e.g., neighborhood 16332). However, if both concepts are candidates in the analysis of a document, both candidates may impute a “Chicago Cubs” concept, not explicitly mentioned on in the document. By each of them imputing “Chicago Cubs,” it can be determined that Jack Brickhouse is the correct referent of the feature “Brickhouse”.

Candidates whose concepts will be used to describe a page can be determined based on the construction of the election. FIG. 21 is a flow chart of an example election method 21414 used in choosing winning concept candidates from a set of candidates in an election (e.g., at 344 in FIG. 3B) according to the present disclosure. The goal of method 21414 may be to select a set of winning candidates that have the property that no feature votes for more than one candidate in the winning candidate set and each feature that votes for any winning candidate votes for the candidate thought to be associated with the concept most likely to be the one the text that led to that feature referred to. To accomplish this, a set of candidates under consideration (the “remaining” candidates) is initialized to be those candidates that have feature votes associated with them, and a score is computed for each candidate as an estimate of the likelihood, based on available evidence, that that candidate's concept was mentioned in the document. Until there are no more remaining candidates, the candidate with the lowest score is removed. As this is the candidate with the lowest score, it is the least likely to be the correct referent for any feature that votes for it. Therefore, for any features that voted for it that also vote for other candidates, the vote from that feature to the removed candidate is removed, which may affect scores of other candidates via the candidate's associated imputations. If there were any features for which there were no other votes, those votes remain and the removed candidate is added to the set of winning candidates, as being the most likely referent for its remaining voters.

At 21416, a set of concept candidates (e.g., 18352) is partitioned in sets containing those concept candidates whose associated vote maps (e.g., map 18356) are empty (“imputed only” candidates) and those concept candidates whose associated vote maps (e.g., map 18356) are non-empty (“remaining” candidates, as discussed above). At 21418, an empty set of winning candidates is constructed.

At 21420, each candidate's initial score (e.g., score 18372) is computed. First candidates with votes (those in the “remaining” set) have their scores initialized to their maximum probability (e.g., probability 18358). Next imputed-only candidates have their scores initialized to the maximum over the candidate's imputing candidates' imputations (e.g., imputation 18374) of the imputations' imputed probability (as described above with respect to FIG. 19). In alternative examples other rules may be used to compute the initial values for these scores. At 21422, means are established for keeping track of the number of votes to any candidate associated with each feature. In alternative examples, the elements of splitting candidates into “remaining” and “imputed only” candidates at 21416 may be performed in a different order.

At 21424, while the “remaining candidates” set is not empty, loop 21425 is performed to select, remove, and process candidates. At 21416, for each remaining candidate (e.g., for each candidate in the “remaining candidates” set), loop 21427 is performed to update its current score (e.g., score 18372). At 21428, a determination is made as to whether the current concept candidate is inactive (e.g., has a false active indication 18368 due to having an empty vote map 18356 and an empty imputing candidates set 18374). If this is the case, the candidate is removed from the set of remaining candidates at 21430, and control passes to the next iteration of loop 21427 at 21431. At 21432, a determination is made as to whether the current concept candidate has no associated votes (e.g., has an empty vote map 18356). If this is the case, at 21434, the candidate is removed from the set of remaining candidates and added to the set of imputed-only candidates, and control passes to the next iteration of loop 21427 at 21431. At 21440, a new score is computed for the candidate but not set as the candidate's current score (e.g., score 18372). Details of methods for computing of the new score will be given below.

At 21442, a determination is made as to whether the new score is below a threshold (e.g., 0.05). If it is below the threshold, at 21444, the candidate is removed from the set of remaining candidates, and for each of the features voting for it, the vote from that feature to the candidate is removed and the total number of votes for that feature is decreased. If the candidate was removed at 21444, control then passes to the next iteration of loop 21427 at 21431. Otherwise, at 21454, the new score is associated with the current concept candidate in a map. By doing so, each candidate's score can be based on the scores of other candidates after the prior iteration.

When loop 21427 terminates, at 21436, for each imputed-only candidate, loop 21437 is performed. At 21438, a new score is computed for the candidate as the maximum value of the imputed probability of the imputations (e.g., imputation 19376) in the candidate's imputing candidates set (e.g., set 18374) and this score is associated with the candidate in a map. In the example, the same map is used as is used at 21443. In alternative examples, other rules may be used for computing the new score. Control then passes to the next iteration of loop 21437 at 21439.

When loop 21437 terminates, at 21446, the scores associated with candidates at 21443 and 21438 are assigned as new values of the respective candidate's current scores (e.g., score 18372).

At 21448, a “worst” candidate can be chosen from the imputed only set. The determination that a candidate C is worse than a candidate C (and therefore more worthy of being chosen) may be based on CL's current score (e.g., score 18372) being less than that of C₂. In some examples, if the difference between the current scores is sufficiently small (e.g., less than 0.001), other means of making the determination may be used. In some such examples, the secondary determination may be based on C₁'s probability (e.g., maximum probability 18358) being less than that of C₂. If these probabilities are sufficiently close to one another (e.g., less than 0.05 apart), still further considerations, such as a comparison between C₁'s vote total (e.g., total 18366) and that of C₂. In some examples, the sequence of tests may include the same test both with and without a threshold or with multiple thresholds. In the example, the sequence of tests consists of a comparison of current score, with a threshold of 0.001, a comparison of maximum probability, with a threshold of 0.05, a comparison of vote total, and a comparison of maximum probability, with no threshold. If no test distinguishes two concept candidates, they are considered to be indistinguishable, and either may be chosen as worse.

At 21450, the identified worst candidate is removed from the set of remaining candidates. At 21452, for each feature in the worst candidate's vote map (e.g., map 18356), if this is not the sole remaining vote for that feature, the feature's vote for the worst candidate is removed. At 21456, a determination is made as to whether the worst candidate has remaining votes (e.g., votes not removed at 21452). If it does, it is added at 21458 to the set of winning candidates created at 21418. In either case, control passes to the next iteration of loop 21425 at 21459.

Following method 21414, additional candidates may be added, in some examples, to the set of winning candidates from the set of imputed-only candidates. In some such examples, a score is computed for each imputed-only candidate as at 21440 (rather than as at 21438) and this score is compared to a threshold (e.g., the threshold used at 21442). If the score is above the threshold, the candidate is added to the set of winning candidates and its score remembered, as at 21443. When all imputed-only candidates have been processed, the remembered scores are assigned as at 21446.

When a feature is dropped as a voter for a candidate, for example at 21444 or 21452, this can result in the candidate no longer having any votes. As a result, whether the candidate remains active can depend on whether its imputing candidates set (e.g., set 18374) is empty. If it is still active, each of the imputations (e.g., imputation 19376) in the imputed candidates set (e.g., set 18360) can be considered, and the feature can be removed from each imputation's target's (e.g., 19378) imputing features multiset (e.g., multiset 18362). If it is no longer active, the imputations (e.g., imputation 19376) imputed candidates (e.g., candidates 18360) can be considered, and each imputation's target candidate (e.g., target candidate 19378) can be instructed to remove the imputation. The imputed candidate can do this by removing the imputation from its imputing candidates set (e.g., set 18374), and if this results in it no longer being active, it can further walk its imputed candidates set (e.g., set 18360) and ask that the imputations contained there be removed from their targets. In some examples, when a feature is removed as a voter for a candidate, this may trigger a new computation of the maximum probability (e.g., probability 18358) for that candidate over the remaining features in the candidate's vote map (e.g., map 18356).

In an example, the computation of a new score for a concept candidate (e.g., candidate 18352), at 21440 makes use of a modified version of the likelihood computation of a Naïve Bayes classifier. In a Naïve Bayes classifier, the likelihood ratio for a particular class C given a set of evidence E is computed as the product of a base likelihood ratio

$$\frac{P ( C )}{P ( \overline{C} )}$$

based on a prior estimate of unconditional probability P(C), and the likelihood ratios of the conditional probability of each piece of evidence e give the class

$$C ( e . g . , \frac{P ( e \vert C )}{P ( e \vert \overline{C} )} ) .$$

### That is,

$$\frac{P ( C \vert E )}{P ( \overline{C} \vert E )} = \frac{P ( C )}{P ( \overline{C} )} {\prod }_{e ∈ E} \frac{P ( e \vert C )}{P ( e \vert \overline{C} )}$$

Since P(C|E)+P( C̅|E)=1, the actual conditional probability of the class given the evidence is therefore

$$P ( C \vert E ) = \frac{\frac{P ( C \vert E )}{P ( \overline{C} \vert E )}}{1 + \frac{P ( C \vert E )}{P ( \overline{C} \vert E )}} ,$$

under the assumptions that all eεE are independent of one another.

In the example, score computation method the base prior estimate P(C) of unconditional probability is taken to be the maximum probability (e.g., probability 18358) associated with that candidate and the evidence is taken to be the presence or absence of support for each imputation in its imputed candidates (e.g., candidates 18362) and interesting candidates (e.g., candidates 18370) sets. In alternative examples, other base prior estimates of unconditional probability may be used. In some examples, the prior estimate may be based on a fraction of documents in some corpus that are determined to be associated with the candidate's concept. In alternative examples, other evidence may be used instead of or in addition to imputations. In some such examples, the evidence may be features in the feature count map.

An imputation from C to a candidate X is considered to be supported if X is active and if at least one feature in X's imputing features (e.g., features 18362) that is not also contained in C's vote map (e.g., map 18356). That is, if there is some feature evidence that leads us to believe that X is present that might not also be evidence for C. When an imputation (e.g., imputation 19376) is supported, the likelihood ratio used in the computation is the imputation's positive likelihood ratio (e.g., ratio 19380) raised to the power of the imputation's probability (e.g., probability 19384). In alternative examples, other likelihood ratios may be used. In some such examples, the imputation's positive likelihood ratio (e.g., ratio 19380) may be used directly. When an imputation (e.g., imputation 19376) is not supported, the likelihood ratio used is the imputation's negative likelihood ratio (e.g. ratio 19386). In alternative examples, other likelihood ratios may be used.

The final score may be computed as P(C|E) above, given the prior probability and evidence likelihood ratios. That is, the likelihood ratio is computed and converted to a conditional probability by dividing the likelihood ratio by one more than the likelihood ratio. In the case when this computation results in an infinite value, the score is taken to be 1.0.

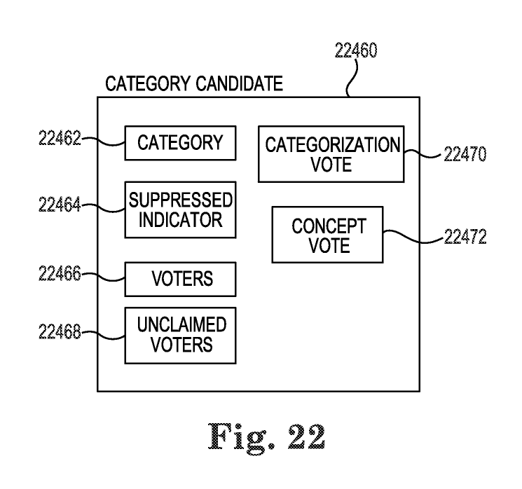

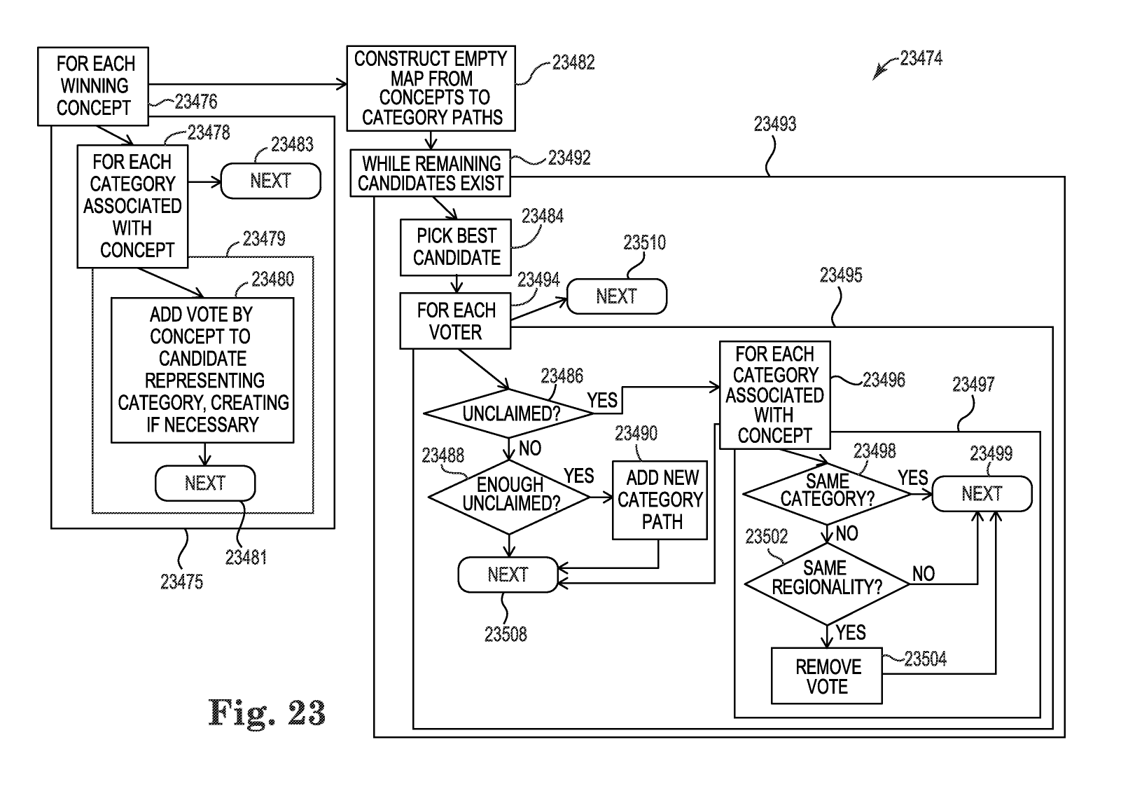

FIGS. 22 and 23 depict objects and methods used in an example for constructing a map from concepts to sets of category paths (e.g., as at 346 in FIG. 3B) based on a set of winning concept candidates 18352 (e.g., as constructed by method 21414) and a categorization 12226 (e.g., as produced by categorizer 13238 at 328 in FIG. 3A).

FIG. 22 is a block diagram of an example category candidate 22460 according to the present disclosure. Category candidate 22460 can be used with respect to method 23474 in FIG. 23. Category candidate 22460 includes an associated category 22462, an indication of whether the category is suppressed 22464, and a “categorization vote” 22470 based on the score associated in the categorization 12226 with the category 22462. The category candidate also includes a set of concept candidates voting for it 22466 and a set of “unclaimed” concept candidates voting for it 22468. In the example, the “unclaimed” set 22468 is a subset of the voters set 22466 containing those concept candidates that have not already been associated by the selection method with any similar category candidate, where two category candidates are considered similar if their associated categories 22462 are either both regional categories or both non-regional categories. In alternative examples, there may be more or fewer classes of categories. In some examples, a category may be considered to be a member of more than one class. The category candidate 22460 also includes a a total concept vote 22472 computed as the sum of the final scores (e.g., score 18372) of the concept candidates contained in both the voters set 22466 and the unclaimed voters set 22468, where if a concept candidate is in both sets, its score is counted twice. In alternative examples, other rules may be used to compute the concept vote 22472.

The score for a category candidate 22460 in the example is computed as the product of the categorization vote and the concept vote. In the example, the categorization vote is computed as

$${b}^{\frac{s - k * t}{t - k * t}} ,$$

where s is the score given to the category 22462 in the categorization 12226, t is the category's threshold according to the categorizer (e.g., categorizer 13238) that constructed the categorization (e.g., categorization 12226), and b and k are parameters. For the expression above, b is the categorization vote for a category whose score is precisely at its threshold, and k is be the number of multiples of threshold that a score would have to be for the categorization value to be 1.0. In an example, b=0.8 and k=2.

FIG. 23 is a flow diagram of an example method 23474 for constructing a map from concepts to sets of category paths (e.g., as at 346 in FIG. 3B) given a set of winning concept categories and a categorization 12226 according to the present disclosure. At 23476, for each winning concept candidate (e.g., candidate 18352), loop 23475 is performed. At 23478, for each category associated with the concept candidate's concept (e.g., concept 18354), loop 23479 is performed. At 23480, a category candidate (e.g., candidate 22460) associated with the category is found (and, if necessary created based on the categorization 12226) and the concept candidate (e.g., candidate 18352) is added to the category candidate's voters set (e.g., set 22466) and unclaimed voters set (e.g., set 22468), adjusting the category candidate's concept vote (e.g., vote 22472). Control then passes to the next iteration of loop 23479 at 23481. When loop 23479 completes, control passes to the next iteration of loop 23475 at 23483.

When loop 23475 completes, at 23482, an empty map from concepts to collections of category paths is created or otherwise obtained. At 23492 the set of known category candidates 22460 is constructed and designated as the set of remaining category candidates. While this set is non-empty, loop 23493 is performed.

At 23484, the best category candidate is chosen from among the remaining category candidates and removed from the set of remaining category candidates. In the example, category candidates 22460 whose categories 22462 are not suppressed are considered better than those whose categories 22462 are suppressed. Otherwise, a sequence of tests is performed until one is found that distinguishes the category candidates. The example sequence prefers category candidates that have higher scores, then higher concept votes (e.g., votes 22472), then more unclaimed voters (e.g., voters 22468), then more voters (e.g., voters 22472), then higher categorization votes (e.g., votes 22470). Category candidates that are the same for all tests are considered to be indistinguishable, and either may be considered better than the other. As with comparing concept candidates, as described above, in alternative examples, tests may include absolute or relative thresholds such that if the difference between two category candidates is less than the threshold, the test does not distinguish the category candidates.

At 23494, for each concept candidate in the best category candidate's set of voters (e.g., set 22466), loop 23495 is performed. At 23486, a determination is made as to whether the concept candidate is also in the category candidates' set of unclaimed voters 22468. If it is, then at 23496, the for each category associated with the concept candidate's associated concept, loop 23497 is performed. At 23498, a determination is made as to whether the current category is the same as the best category candidate's associated category 22462. If they are, control passes to the next iteration of loop 23497 at 23499. At 23502, a determination is made as to whether the current category has the same regionality as the best category candidate's associated category 22462 (e.g., are they both regional categories or both non-regional categories).

In alternative examples, as described above, more or fewer such category classes may be employed. In such examples, the determination may be whether the categories share any classes, all classes, a sufficient number of classes, or some other criterion. If the categories are determined to not have the same regionality, control passes to the next iteration of loop 23497 at 23503. At 23504, the current concept candidate is removed from the set of unclaimed voters 22468 in the category candidate associated with the current category, and that category candidate's concept vote 22472 is updates. Control then passes to the next iteration of loop 23497 at 23503.

Returning to the unclaimed determination at 23486, if the determination is that the concept candidate is not in the unclaimed voters set 22468, at 23488, a determination is made as to whether the category candidate contains enough unclaimed voters to proceed anyway. In the example, a category candidate is considered to have enough unclaimed voters if the size of the unclaimed voters set (e.g., set 22468) is at least half the size of the voters set (e.g., set 22466). In alternative examples, other rules and thresholds may be employed. In alternative examples, the “enough unclaimed” determination at 23488 may be omitted, with control flowing as though the determination had been that the number of unclaimed was insufficient. If it is determined that there are not enough unclaimed voters, control passes to the next iteration of loop 23495 at 23508.

If there are enough unclaimed voters at 23488 or if the current concept candidate is unclaimed and following 23496, at 23490 a new category path object is created combining the category (e.g., category 22462) associated with the best category candidate (e.g., candidate 22460) and the concept (e.g., concept 18354) associated with the current concept candidate (e.g., candidate 18352). A collection of category paths associated with the concept is obtained from the map created at 23482 (creating it, if necessary), and the newly-created category path is added to the collection. Control then passes to the next iteration of loop 23495 at 23508. When loop 23495 terminates, control passes to the next iteration of loop 23493 at 23510.

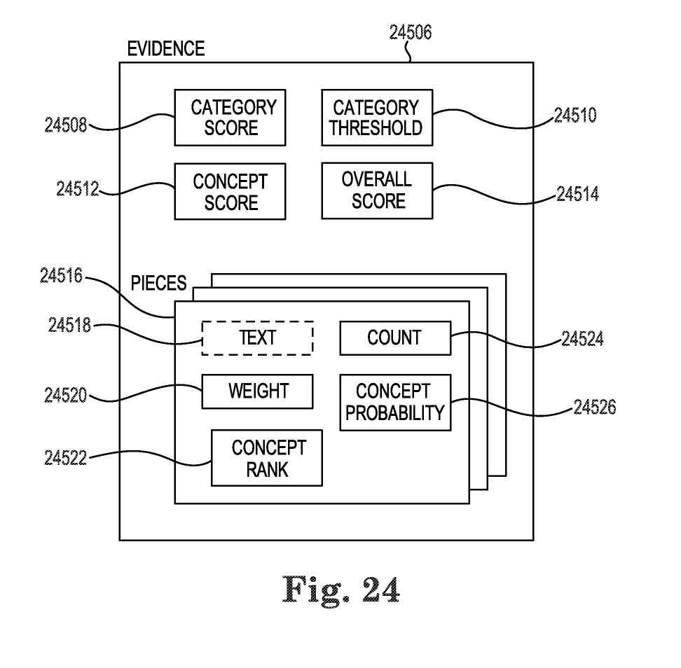

FIGS. 24 and 25 depict objects and methods used in an example for associating evidence objects with category paths (e.g., as at 348 in FIG. 3B) based on a set of winning concept candidates (e.g., candidate 18352 as constructed by method 21414), a categorization (e.g., categorization 12226 as produced by categorizer 13238 at 328 in FIG. 3A), a feature count map (e.g., map 11196), and a map from concepts to category paths (e.g., as constructed by method 23474).

FIG. 24 is a block diagram of an example evidence object 24506 according to the present disclosure. Evidence object 24506 can be used with respect to method 25528 in FIG. 25 and representing a synopsis of the evidence for the relevance of a particular category path to a document. A constructed evidence object 24506 can include a category score 24508 (e.g., a score due to the category path's category), a category threshold 24510, a concept score 24512 (e.g., a score due to the category path's concept), and an overall score 24514 computed using a scoring function (e.g., scoring function 216, as illustrated in FIG. 2). The evidence object 24506 can also contain a list of pieces of evidence 24516. The scoring function can assign a score to each category path based on associated evidence, and each piece in the list of pieces can represent one feature that provides evidence for a concept. Each piece of evidence 24516 can include, a count 24524 (e.g., the count associated with the feature in feature count map 11196), a weight 24520 (e.g., the weight associated with the feature in feature count map 11196), a concept probability 24526 (e.g., the probability associated with the concept in the feature's associated feature record 10174), and a concept rank 24522 (e.g., the rank of the concept in the feature's associated feature record 10174). In some examples, a piece of evidence 24516 may also include a text object 24518 (either a string or an object that can be turned into a string on demand) for display, debugging, or other purposes.

FIG. 25 is a flow chart of an example method 25528 for associating evidence objects with category paths (e.g., as at 348 in FIG. 3B) according to the present disclosure. At 25530, for each winning concept candidate, loop 25531 is performed. At 25532, for each category path associated with the concept candidate's associated concept, loop 25533 is performed. At 25534, a new evidence object is constructed based on the categorization (e.g., categorization 12226), the category associated with the category path (to determine the category score 24508 and category threshold 24510) and the score (e.g., score 18372) associated with the concept candidate (to determine the concept score 24512) and this evidence object is associated with the current category path. At 25536, for each feature in the concept candidate's vote map (e.g., map 18356), loop 25537 is performed. At 25538, a new piece of evidence (e.g., evidence 24516) is constructed based on the feature and added to the evidence object (e.g., evidence object 24506) constructed at 25534. Control then passes to the next iteration of loop 25537 at 25539. When loop 25537 terminates, control passes to the next iteration of loop 25533 at 25559.

When loop 25533 terminates, at 25540, for each imputation in the concept candidate's set of imputing candidates (e.g., 18374), loop 25541 is performed. At 25542, for each of feature in the vote map (e.g., map 18356) of the current imputation's source candidate (e.g., candidate 19382), loop 25543 is performed. At 25544, a piece of evidence (e.g., evidence 24516) is constructed, substantially as at 25538, but with a count (e.g., count 24524) and a weight (e.g., weight 24520) discounted based on the current imputation (e.g., by multiplying by the current imputation's imputed probability). Control then passes to the next iteration of loop 25543 at 25545. When loop 25543 terminates, control passes to the next iteration of loop 25541 at 25547. When loop 25541 terminates, control passes to the next iteration of loop 25531 at 25553.

When loop 25531 terminates, the associations between category paths and evidence objects may be used as evidence map (e.g., map 12228) in the constructed analysis (e.g., analysis 12222).

A scoring function (e.g., function 216) can be applied to each evidence object (e.g., object 24506) in the evidence map to annotate it with an overall score (e.g., score 24514 and as illustrated in FIG. 3A at 338). In the example, the scoring function computes the overall score (e.g., score 24514) of an evidence object (e.g., object 24506) as the product of a category component and a concept component. The category component is computed in the same manner as the categorization vote (e.g., vote 22470) of the category candidate (e.g., candidate 22460) as described above with respect to FIG. 22. In alternative examples, other methods or other parameterizations of this method may be used. The concept component is computed as the sum of the weights (e.g., 24520) attached to each of the pieces of evidence (e.g., 24516) in the evidence object (e.g., object 24506). In alternative examples, other methods for computing the concept component, for combining the concept component and the category component, or for computing the overall score may be employed.

As discussed with respect to FIG. 12, the analysis object constructed at 337 in FIG. 3A may have a scale factor (e.g., factor 12224) to allow an interpretation of the overall score (e.g., score 24514) of each evidence object to be guaranteed to be less than one. In an example, this scale factor (e.g., factor 12224) may be the maximum of the constant one and the maximum overall score (e.g., score 24514) over any evidence object (e.g., object 24506) in the evidence map (e.g., map 12228).

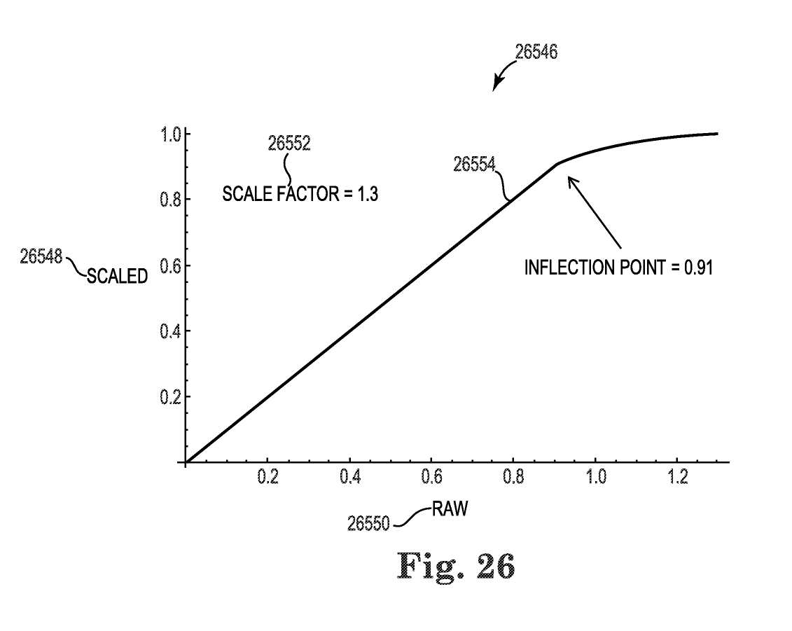

The use of an overall score 24514 and a scale factor 12224, results in a scaled score. FIG. 26 is a diagram of an example comparison of a raw score and a scaled score according to the present disclosure. In an example, the scale factor may be obtained by dividing the overall score (e.g., score 24514) by the scale factor (e.g., factor 12224). This can have sub-optimal results when the evidence map contains a few scores that are substantially higher than others, as the non-high scores may become unreasonably small. In an example, the scaled score is computed using a function that has a linear part and a quadratic part, yielding a smoother fall-off with high vales. In this example, the scaled score ŝ, for a given raw overall score (e.g., score 24514) s and scale factor (e.g., factor 12224) F can be computed as follows:

$$\hat{s} = min ( s , 1 - {( \frac{F - s}{F} )}^{2} ) .$$

The function has a maximum value of one, and is linear up to 2F−F², with a quadratic compression afterwards. When the scale factor is 1 (e.g., when all overall scores 24514 are less than or equal to 1), the entire curve is be linear. When the scale factor is two or more, the entire curve is compressed. In between, the curve is mostly linear, but compressed on top, as shown by curve 26554 in FIG. 26.

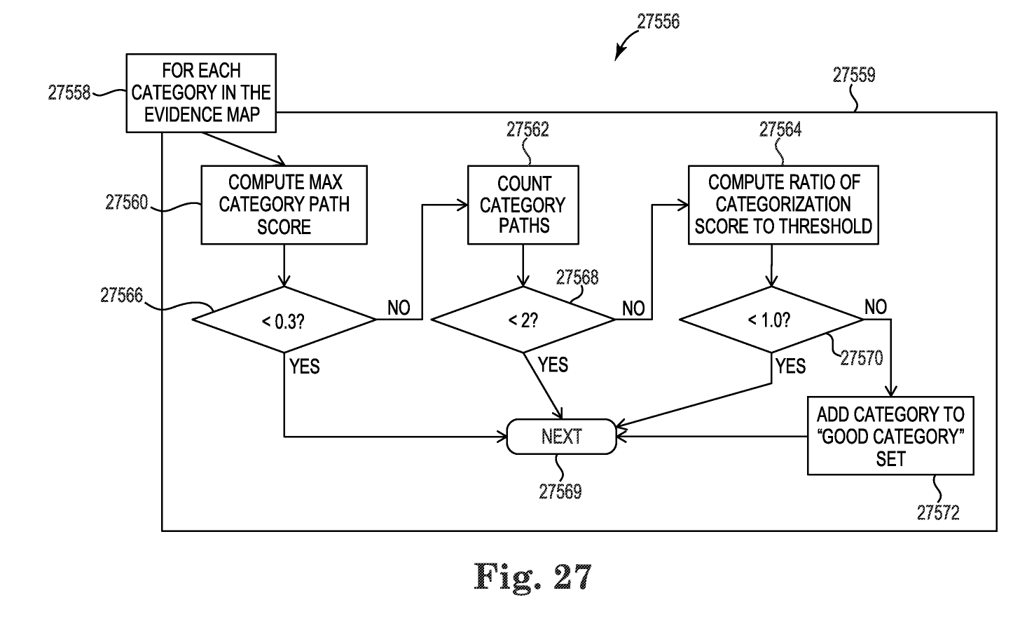

A category path filter can be applied (e.g., as illustrated in FIG. 3A at 340) to weed out category paths with categories that may be mistakes, or, for example, are almost certainly mistakes (e.g., as illustrated in FIG. 3A at 340). FIG. 27 is a flow chart of an example method 27556 for filtering category paths according to the present disclosure. A category path filter can determine which category paths are worth including in an analysis (e.g., analysis 12222) of a document based on support in the text of a document for the category paths' categories. At 27558, for each category in any category path in the evidence map (e.g., map 12228), loop 27559 is performed. At 27560, a score (e.g., a maximum scaled score) for the evidence associated with any category path having the current category in the evidence map is computed. At 27566, a determination is made as to whether this score is less than a given threshold score (e.g., 0.3). In alternative examples, other criteria may be used to determine that no category path with the current category has a sufficiently high score. If the determination is that the score is less than the threshold, control passes to the next iteration of loop 27559 at 27569. At 27562, the number of category paths having the current category in the evidence map is computed. At 27562, a determination is made as to whether this count is less than a given threshold count (e.g., 2).

In alternative examples, other criteria may be used to determine that an insufficient number of category paths with the current category exist in the evidence map. If the determination is that the count is less than the threshold, control passes to the next iteration of loop 27559 at 27569. At 27564, the ratio of the categorization score associated with the current category and the categorization threshold associated with the current category is computed. At 27564, a determination is made as to whether this ratio is less than a given threshold (e.g., 1.0). In alternative examples, other criteria may be used to determine that the categorization score for the category is insufficiently high. If the determination is that the ratio is less than the threshold, control passes to the next iteration of loop 27559 at 27569. At 27572, the current category is added to good category set (e.g., set 12230) in the analysis (or to a collection that will become good category set 12230 in the analysis) and control passes to the next iteration of loop 27759 at 27569.

In alternative examples, method 27556 may be performed in substantially different order. For example, a pass may be made through all of the category paths in the evidence maps, collecting the count and score (e.g., maximum score) for the categories as they are encountered and a second pass made over the categories encountered to determine whether they pass or fail the tests. In alternative examples, some or all of the example tests may be omitted and other tests may be added. In some examples, tests may be made as to whether categories are suppressed or otherwise inherently to be excluded. In alternative examples, a category may be determined to be a good category based on passing fewer than all of the tests. In some examples, rather than collecting “good” categories, the category path filter may collect “bad” categories based on categories failing tests. In some examples, rather than creating a separate collection of good or bad categories, the category path filter may remove categories associated with category paths that fail tests from the evidence map.

Using the collected information, an analysis object can be constructed based on the document, and this analysis object, alone or in combination with other analysis objects obtained by analyzing other documents, can be used in the performance of actions related to the document, to other documents, or to other objects or entities related to the document. Such other objects or entities include, without limitation, users who have (or have not) interacted with the document, who have purchased the document, or who have expressed or been determined to have an opinion about the document, storage locations (including disks, servers, and web sites) that contain or contain references to the document, and information sources (including web sites, blogs, RSS feeds, newspapers, television shows, and authors, including users of Twitter or social media) who make reference to or discuss the document.

Examples of actions that may be performed include, without, limitation, classifying the document, recommending the document to a user, including the document in a publication, altering the configuration of a location of the document so as to emphasize the document or make it easier to find, determining a price to charge for accessing the document, determining a location for the document, sending a reference to the document to a user, and determining a management policy to apply to the document. In each of these, “the document” should be read as including other documents, and other objects or entities related to the document.

A document can be further used to synthesize, over a large number of document viewings, a profile that describes sudden interests of a user, long-term interests (e.g., concepts and categories that show up again and again), and other interests. The profile can include the interests of a user, and the profile and document analysis can also be used to personalize content served to the user to increase satisfaction, to recommend content, to decide how similar multiple users' interests are, or display a graphical representation of a user's interests. The comparison of multiple users' interests can be used for collaborative filtering, among other uses. The graphical representation can be used as a selling feature for devices and other services, among other uses.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A method for constructing an analysis of a document, comprising:
determining a plurality of features based on the document, wherein each of the plurality of features is associated with a subset of a set of concepts;
constructing a set of concept candidates based on the plurality of features, each concept candidate associated with at least one concept in the set of concepts;
choosing a subset of the set of concept candidates as winning concept candidates; and
constructing an analysis that includes at least one concept in the set of concepts associated with at least one of the winning concept candidates.

2. The method of claim 1, wherein a feature in the plurality of features is a potential concept indicator, and wherein choosing the subset of the set of concept candidates includes selecting a concept from the subset of the set of concepts associated with the feature as a referent for that feature.

3. The method of claim 1, wherein the subset of concept candidates are chosen based on a first weighted association between one of the plurality of features and a first concept candidate in the set of concept candidates.

4. The method of claim 3, wherein choosing the subset of concept candidates as winning concept candidates comprises:
determining a first vote associated with the first concept candidate based on the first weighted association;
determining a second vote associated with a second concept candidate in the set of concept candidates based on a second weighted association between the one of the plurality of features and the second concept candidate;
selecting the first concept candidate as a winning concept candidate; and
removing the second vote.

5. The method of claim 1, wherein choosing the subset of concept candidates as winning concept candidates is based on a conditional probability between a first concept candidate and a second concept candidate.

6. The method of claim 1 further comprising adding a first concept candidate associated with a first concept to the set of concept candidates based on a conditional probability between the first concept and a second concept associated with a second concept candidate in the set of concept candidates.

7. The method of claim 1, further comprising excluding a first one of the plurality of features from being used to construct the set of concept candidates based on the presence of a second one of the plurality of features.

8. The method of claim 1, further comprising mapping each of the plurality of features to an object that indicates a number of times each of the plurality of features appears in the document.

9. The method of claim 8, wherein the number of times that a first feature appears in the document is based on the number of times a second feature appears in the document.

10. A system for constructing an analysis of a document, comprising:
a memory;
a processor coupled to the memory, to:
determine, based on a plurality of features extracted from the document, a set of categories that organize a set of concept candidates within the set of categories;
choose a subset of the set of concept candidates as winning concept candidates using a feature weight and a concept probability;
wherein the feature weight indicates a distribution of a feature in the document and the concept probability includes a likelihood that a first concept candidate is in the subset if a second concept candidate is in the subset; and
construct an analysis, wherein the analysis includes an association between a concept associated with a first one of the winning concept candidates and a category in the set of categories.

11. The system of claim 10, wherein the winning concept candidates are further chosen based on the set of categories.

12. The system of claim 10, wherein the analysis further includes a category path demonstrating a sequence of progressively narrower categories in the set of categories, the category path associated with a second one of the winning concept categories.

13. The system of claim 10, wherein an action is performed based on the constructed analysis, and wherein the action includes at least one of synthesizing a user profile, classifying the document, recommending the document to a user, including the document in a publication, altering the configuration of a location of the document so as to emphasize the document or make it easier to find, determining a price to charge for accessing the document, determining a location for the document, sending a reference to the document to a user, and determining a management policy to apply to the document.

14. A computer-readable non-transitory medium storing a set of instructions for constructing an analysis of a document executable by the computer to cause the computer to:
associate each of a plurality of features extracted from the document with a set of concepts and construct a first concept candidate and a second concept candidate based on the plurality of features;
choose the first concept candidate as a winning concept candidate based on a conditional probability between the first concept candidate and the second concept candidate;
compute a score for the winning concept candidate; and
construct an analysis based on the score, wherein the analysis includes a concept associated with the winning concept candidate.

15. The medium of claim 14, wherein the score is indicative of at least one of a degree to which the document is about the concept and a confidence that the concept is mentioned in the document.
